(19) United States
(12) Patent Application Publication
(10) Pub. No.: US 2012/0053996 A1
(43) Pub. Date: Mar. 1, 2012

(54) SYSTEM AND METHOD FOR OBJECTIVE PERFORMANCE EVALUATION IN EMPLOYMENT RECRUITING PROCESS

(75) Inventor: Frantisek GALBAVY, Houston, TX (US)

(73) Assignee: FRANKMON GROUP, S.R.O., Handlova (SK)

(21) Appl. No.: 12/873,258

(22) Filed: Aug. 31, 2010

Related U.S. Application Data
(60) Provisional application No. 61/378,737, filed on Aug. 31, 2010.

(51) Int. Cl. G06Q 90/00; G06Q 10/00

(52) U.S. Cl. 705/7.42; 705/321

(57) ABSTRACT

System/method for managing an employment recruitment process comprises one or more databases configured to store data concerning recruiters, referrers, hirers, jobs, and employment candidates. At least one server is connected to the databases and configured to, among other things, automatically award or deduct points for a participant of the employment recruitment process, based on the participant's performance in the process, using one or more objective criteria, the awarding or deducting being conducted without scoring-related input from other participants in the process. The server then provides a performance index for each participant, the performance index composed of a performance percentage and number of events, where an event is a recruiting related action for which points were awarded or deducted by the server, and the performance percentage is a percentage reflecting the number of points a participant has earned relative to the total number of points that the participant could have earned.

### CROSS REFERENCE TO RELATED APPLICATIONS

This application for patent claims priority to, and hereby incorporates by reference, U.S. Provisional Application Ser. No. 61/378,737, entitled “System and Method for Objective Performance Evaluation in Employment Recruiting Process,” filed Aug. 31, 2010.

### STATEMENT REGARDING FEDERALLY SPONSORED RESEARCH

Not applicable.

### REFERENCE TO APPENDIX

Not applicable.

### COPYRIGHT NOTICE

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### BACKGROUND OF THE INVENTION

1. Field of the Invention

This disclosure relates generally to systems and methods for managing and tracking the activities of participants in an employment recruiting process. More specifically, this disclosure relates to systems and methods for automatically providing objective performance evaluations of employers, recruiters, and referrers in the employment recruiting process.

2. Description of the Related Art

Participants in the employment process generally include employers (or hirers), employment candidates, and intermediaries like recruiters and referrers who bring the employers and the employment candidates together. The employers are most often hiring managers, while employment candidates are people with certain job-related skills and/or experience who wish to be hired by the employers. Intermediaries, also called brokers, may be single individuals, groups, or organizations, and may also include job boards (e.g., Monster.com, HotJobs.com, CareerBuilder, etc.), social networks (e.g., Linkedin.com, Xing.com, etc.) as well as software applications (e.g., job/resume posting systems).

Brokers are essentially matchmakers who attempt to optimize the match between the job requirements of an employer and the skill sets of employment candidates, typically for a fee (e.g., 20% of the candidate's first-year salary, etc.). In order to determine if there is a potential match, the primary vehicles used by brokers is the job specifications for employers and the resumes for employment candidates. Entire industries have formed around the brokering of employment in virtually every industrialized country in the world.

There are essentially two types of brokers: recruiters and referrers. Both perform similar functions, namely, bringing employment candidates to the attention of employers or hirers, and acting as intermediaries between the employment candidates and the hirers. Referrers may also bring candidates to the attention of recruiters, and vice versa. However, recruiters typically work for a firm or company, while referrers do not. Another distinction is that recruiters may negotiate their service fees with the hirers for whom they provide candidates, whereas referrers are typically not paid. In some instances the referrers may be paid a referral fee. Indeed, with regard to that referral fee, it is a common practice for recruiters to provide employers with only a minimal amount of details (e.g., partial resume) about a candidate, holding back the full details of the candidates until a service charge has been mutually agreed upon.

Presently, there are numerous companies that identify themselves as recruiting firms. Their role is to find employment candidates who meet the specific job requirements of their client organizations. There are also numerous companies that classify themselves as employment agencies or placement firms. These agencies operate to bring employers and employment candidates together, but often for temporary or contract employment situations. Many companies have their own in-house recruiters who help fulfill the employment needs of their respective companies. In addition, there are numerous job boards, like the ones mentioned above, that help make employers and employment candidates visible to each other by posting the job requirements of employers and the resumes of employment candidates online and allowing the parties to search for suitable matches.

Existing brokering mechanisms and processes, however, tend to be inefficient and ineffective. Currently, for example, employers or hirers receive numerous phone calls from recruiters wanting to offer their services. These phone calls take precious time from the hirers, leaving them less time to spend dealing with their job-related responsibilities. Additionally, when hirers receive phone calls from recruiters, the hirers mainly have to rely on information that is being provided by the recruiters themselves. The hirers may, of course, check the recruiters' references, but this is a time-consuming process that is in any event largely ineffectual because the hirers are relying on a third party's opinion, which may potentially be biased. Also, hirers would like to tap into the huge network of potential referrers but currently there is no system efficient system of connecting these two together. In short, there is currently no way for the hirers to quickly, objectively, and meaningfully evaluate the recruiters and referrers to determine whether they can or will perform at an acceptable level.

Likewise, there is currently no way for recruiters and referrers to quickly, objectively, and meaningfully evaluate a hirer to determine whether it would be worthwhile to work with the hirer. Compounding the problem, many hirers are employed by companies that have poor recruitment process management and/or are woefully understaffed. As a result, recruiters and referrers, and the employment candidates they introduce, are often made to wait long periods of time for feedback or responses, or do not receive any response at all.

As for the employment candidates, while there are services and Web sites that allow such candidates to refer themselves to recruiters, referrers, or directly to hirers, these services and Web sites give the candidates little or no control over the recruitment process once their resumes are submitted. Often the candidates do not even know what will happen to their resumes after submission.

Accordingly, what is needed is an improved system and method for managing and tracking the activities of participants in the employment recruiting process. More particularly, what is needed is an improved system and method for automatically and objectively scoring or rating the performance of recruiters, referrers, and hirers in the employment recruiting process, and for making such ratings available so that the recruiters, referrers, and hirers may quickly and conveniently assess one another's suitability, reliability, professionalism, and so forth, with respect to the employment recruiting process.

### SUMMARY OF THE INVENTION

The present disclosure addresses many of the inefficiencies described above. In general, in one aspect, the present disclosure is directed to a computer-based method of managing an employment recruitment process. The method comprises creating a first user account for a first participant in the recruitment process and a second user account for a second participant in the recruitment process, the first user account and the second user account having a first performance index and a second performance index associated therewith, respectively. The method also comprises completing a first recruiting related action selected by the first participant, the first recruiting related action being triggered by completion of a previous recruiting related action selected by the second participant. The method further comprises awarding or deducting points for the first participant for completion of the first recruiting related action based on a first objective criterion. The method still further comprises completing a second recruiting related action selected by the second participant, the second recruiting related action being triggered by completion of a previous recruiting related action selected by the first participant, and awarding or deducting points for the second participant for completion of the second recruiting related action based on a second objective criterion. The method yet further comprises updating the first performance index using the completion of the first recruiting related action and the points awarded or deducted therefor, and updating the second performance index using the completion of the second recruiting related action and the points awarded or deducted therefor, the first and second performance indices providing an objective indication of the past performances of the first and second participants, respectively.

In general, in another aspect, the present disclosure is directed to a computer-based system for standardizing an employment recruitment process. The system comprises at least one subsystem configured to complete a hirer related action selected by a hirer in the recruiting process and at least one subsystem configured to award or deduct points for the hirer for completion of the hirer related action based on a first objective criterion. The system also comprises at least one subsystem configured to complete a recruiter related action selected by a recruiter in the recruiting process, the recruiter related action being triggered by completion of the hirer related action selected by the hirer. The system further comprises at least one subsystem configured to award or deduct points for the recruiter for completion of the recruiter related action based on a second objective criterion. The system still further comprises at least one subsystem configured to update a hirer performance index using the completion of the hirer related action and the points awarded or deducted therefor, and update a recruiter performance index using the completion of the recruiter related action and the points awarded or deducted therefor, the hirer and recruiter performance indices providing an objective indication of the past performances of the hirer and recruiter, respectively.

In general, in a further aspect, the present disclosure is directed to a computer-based system for managing an employment recruitment process. The system comprises one or more databases configured to store data concerning recruiters, referrers, hirers, jobs, and employment candidates, and at least one server connected to the one or more databases and configured to access the data stored on the one or more databases. The at least one server includes a non-transitory storage medium encoded with computer-readable instructions for causing the at least one server to, among other things, automatically award or deduct points for a participant based on the participant's performance in the employment recruitment process using one or more objective criteria, the awarding or deducting being conducted without scoring-related input from other participants in the employment recruitment process, and provide a performance index for each participant, the performance index composed of a performance percentage and number of events, where an event is a recruiting related action for which points were awarded or deducted by the at least one server, and the performance percentage is a percentage reflecting the number of points a participant has earned relative to the total number of points that the participant could have earned.

### BRIEF DESCRIPTION OF THE DRAWINGS

The foregoing and other advantages of the disclosed embodiments will become apparent from the following detailed description and upon reference to the drawings, wherein:

FIG. 1 illustrates an exemplary system and method therefor according to the present disclosure;

FIG. 2 illustrates exemplary databases that may be used with the systems and methods of the present disclosure;

FIG. 3 illustrates an exemplary Web server that may be used with the systems and methods of the present disclosure;

FIG. 4 illustrates an exemplary Web-based recruiting management tool in accordance with the systems and methods of the present disclosure;

FIG. 5 illustrates an exemplary system architecture for the Web-based recruiting management tool in accordance with the systems and methods of the present disclosure;

FIGS. 6-9 illustrate exemplary flowcharts for the Web-based recruiting management tool with respect to a recruiter;

FIGS. 10-12 illustrate exemplary flowcharts for the Web-based recruiting management tool with respect to a referrer;

FIGS. 13-16 illustrate exemplary flowcharts for the Web-based recruiting management tool with respect to a hirer;

FIGS. 17A-17I illustrate exemplary screenshots of a graphical user interface for the Web-based recruiting management tool that may be used by hirers;

FIGS. 18A-18G illustrate exemplary screenshots of a graphical user interface for the Web-based recruiting management tool that may be used by recruiters;

FIGS. 19A-19D illustrate exemplary screenshots of a graphical user interface for the Web-based recruiting management tool that may be used by employment candidates; and

FIGS. 20A-20C illustrate exemplary screenshots of a graphical user interface for a delegation system of the Web-based recruiting management tool that may be used by hirers and recruiters.

### DETAILED DESCRIPTION

The figures described above and the written description of specific structures and functions below are not presented to limit the scope of the disclosed embodiments and the appended claims. Rather, the figures and written description are provided to teach any person skilled in the art to make and use the embodiments for which patent protection is sought. Those skilled in the art will appreciate that not all features of a commercial embodiment are described or shown for the sake of clarity and understanding. Persons of skill in this art will also appreciate that the development of an actual commercial embodiment incorporating aspects of the disclosed embodiments will require numerous implementation-specific decisions to achieve the developer's ultimate goal for the commercial embodiment. Such implementation-specific decisions may include, and likely are not limited to, compliance with system-related, business-related, government-related and other constraints, which may vary by specific implementation, location, and from time to time. While a developer's efforts might be complex and time-consuming in an absolute sense, such efforts would be, nevertheless, a routine undertaking for those of skill in this art having benefit of this disclosure. It must be understood that the embodiments disclosed and taught herein are amenable to numerous and various modifications and alternative forms. Lastly, the use of a singular term, such as, but not limited to, “a,” is not intended as limiting of the number of items. Also, relational terms, such as, but not limited to, “top,” “bottom,” “left,” “right,” “upper,” “lower,” “down,” “up,” “side,” and the like, are used in the written description for clarity in specific reference to the figures and are not intended to limit the scope of the disclosed embodiments or the appended claims.

As stated above, the disclosed embodiments relate to improved systems and methods for managing and tracking the activities of recruiters, referrers, and hirers in the employment recruiting process. In addition, the systems and methods may be used to automatically and objectively score or rate the performance of such recruiters, referrers, and hirers, so that they may quickly and effortlessly assess one another's suitability, reliability, professionalism, and so forth, with respect to the employment recruiting process. The terms “recruiting process” and “recruitment process,” as used herein, generally refer to the process of bringing hirers and employment candidates together to fulfill a given employment need or opportunity. The process encompasses both permanent and temporary (i.e., contract) employment, as well as variations and combinations thereof. Of particular benefit, the systems and methods of the disclosed embodiments divide the employment recruitment process into a series of predefined actions or steps. One or more of these actions or steps may trigger or lead to one or more related actions or steps that depend, at least in part, on actions or steps that were taken previously. This breaking up of the recruitment process into a series of predefined actions or steps has the effect of imposing or enforcing a standardized and uniform process on the participants. These participants, namely, the recruiters, referrers, and hirers may then be scored based on their performances at the various actions or steps in the recruitment process using one or more objective criteria.

As used herein, an “objective” criterion is one that is not readily susceptible to, or easily influenced by, human emotion or feelings such that two people will usually reach the same conclusion given the same conditions or circumstances. A “subjective” criterion, on the other hand, involves an emotional or personal judgment such that two people, despite having the same conditions or circumstances, may arrive at different conclusions. As an example of an objective criterion, the recruiters, referrers, and hirers may be scored based on whether they responded to a request within a predefined period of time, say, seven days. As another example, recruiters and referrers (but not hirers) may be scored based on whether the candidates they submitted were invited for an interview. Other examples abound, such as scoring based on rates or fees charged/paid, the number of candidates submitted, whether an offer of employment was made, whether the candidates remained more than a predefined period of time (e.g., three months) at the hirers company, and so on.

In accordance with the disclosed embodiments, each participant in the recruiting process, whether a hirer, recruiter, or referrer, has two main metrics that are tracked and accumulated for that participant: 1) Performance Percentage, which is a percentage reflecting the number of points a participant has earned, as briefly discussed above, relative to the total number of points that he/she could have earned; and 2) Number of Events, which is the total number of recruiting events that a participant has completed, where a recruiting event is any action or step that may result in points being awarded to or deducted from the participant. These two metrics together are eponymously referred to throughout this description and the drawings as the Frankmon Performance Index (FPI), or sometimes simply PI (Performance Index).

Of the two metrics, the first one, Performance Percentage, provides a general indication of how well a participant has performed in the recruitment process thus far. Each participant in the recruiting process has one or more pre-established scoring criteria that measure the participant's performance. Scoring generally involves awarding a certain number of points to a participant when a certain criterion is met, and deducting a certain number of points when the criterion is not met, or assigning neutral points when the criterion is only partly met. The number of points may vary from criterion to criterion and/or from participant (e.g., hirer, recruiter, or referrer) to participant, or the number of points may be the same for all criteria and all participants. Other variations of the point-participant-criterion relationship are certainly within the ability of those having ordinary skill in the art and are therefore within the scope of the disclosed embodiments. The scores for each participant are then accumulated and used to calculate the Performance Percentage component of the FPI.

As for the second metric, Number of Events, a recruiting event is any action or step that may result in points being awarded to or deducted from a participant. For example, a recruiter receiving a request from a hirer to find candidates for a particular job opening constitutes one recruiting event. Such requests and other notifications of actions or steps that need to be taken may be conveyed between hirers and their recruiters and/or referrers automatically, for example, via internal system messages, as soon as the triggering action or step is completed. The recruiter is then required to respond by either accepting the request or declining it within a predefined period of time, say, seven days. If the recruiter responds within seven days, he/she may be automatically awarded a predefined number of points, say, 10 points. A response coming between seven to 14 days, however, may result in a deduction of, say, five points from the recruiter. And if there is no response after 14 days, the recruiter may be subjected to, for example, a 10-point deduction, and so on. The Number of Events is provided in conjunction with the first metric mainly to mitigate potentially skewed perceptions. For example, a participant who has been involved in only a few events, or only in events that, by design, have a lower number of available points, may have a misleading FPI because his/her relatively low scores are a byproduct of the types and number of events that he/she has been involved in, and are not indicative of how he/she has actually performed. It should be noted that, in a preferred implementation, only hirers, recruiters, and referrers may be scored in the recruiting process of the disclosed embodiments, and that at no time are employment candidates scored or otherwise rated in the process. In other implementations, however, those having ordinary skill in the art may score or rate the candidates as well without departing from the scope of the disclosed embodiments.

The FPI, as reflected by the two metrics above, is then displayed to the individual participant and also made available to his/her reciprocal participants in the recruitment process. The term “reciprocal participants,” as is used herein, refers to other participants with whom an individual participant has contacted or is working to fulfill a specific employment need or opportunity. This FPI operates as an indicator or gauge for the reciprocal participants to give them an idea of how well the individual participant may be expected to perform and/or whether the reciprocal participants would even want to work with the individual participant. Such an arrangement allows a hirer, for example, to make an informed decision regarding whether to assign a search to a particular recruiter. A relatively low FPI, for example, may mean the individual participant is generally unresponsive, unreliable, and/or has not provided many employment candidates of a high caliber (as gauged, for example, by the number of interviews the candidates received). A relatively high FPI, on the other hand, may mean the individual participant usually responds promptly to inquiries and requests and/or consistently provides high-quality candidates. Thus, a hirer may wish to work only with recruiters and referrers who have a high FPI (e.g., above a certain percentage), and recruiters and referrers may wish to submit employment candidates only to hirers with a high FPI, and so forth.

In addition, both the scoring and the resulting Performance Percentage are done automatically, with little and preferably no human intervention, whether through scoring or rating of other participants, or even checking off an action as having been completed by another participant, in the recruiting process. In other words, in a preferred embodiment, both hirers and their recruiters and/or referrers are scored, but not by one another and not manually (although some minor amount of manual, participant-to-participant scoring may be desirable in specific cases). And employment candidates, to the extent they may be considered participants in the recruiting process, are not scored at all in preferred implementations. As a result, all parties involved may be fairly confident that the FPI is entirely (or at least mostly) objective and unbiased. Furthermore, an individual's FPI is personal to that individual and not to the company or firm for whom he/she worked. This means that, in general, the FPI of the individual stays with the individual even when he/she changes company or firm. Such an arrangement allows a recruiter's good reputation, once established, to continue with the recruiter as the recruiter moves between employment opportunities. Similarly, the bad reputation of a hirer remains with the hirer and not the company or firm that employed the hirer. Thus, the hirer with the bad reputation cannot “start over” with respect to his/her FPI simply by changing firms or employers. As a result, recruiters, referrers, and hirers alike may feel more motivated to provide outstanding service and perform at a high level throughout the recruitment process. In some implementations, however, it may be advisable to allow certain participants, such as hirers, to create a new account and effectively reset their FPI after they join another organization. This feature would be particularly useful for participants who may have accumulated a low FPI as a result of working in a dysfunctional organization more so than poor performance on their part.

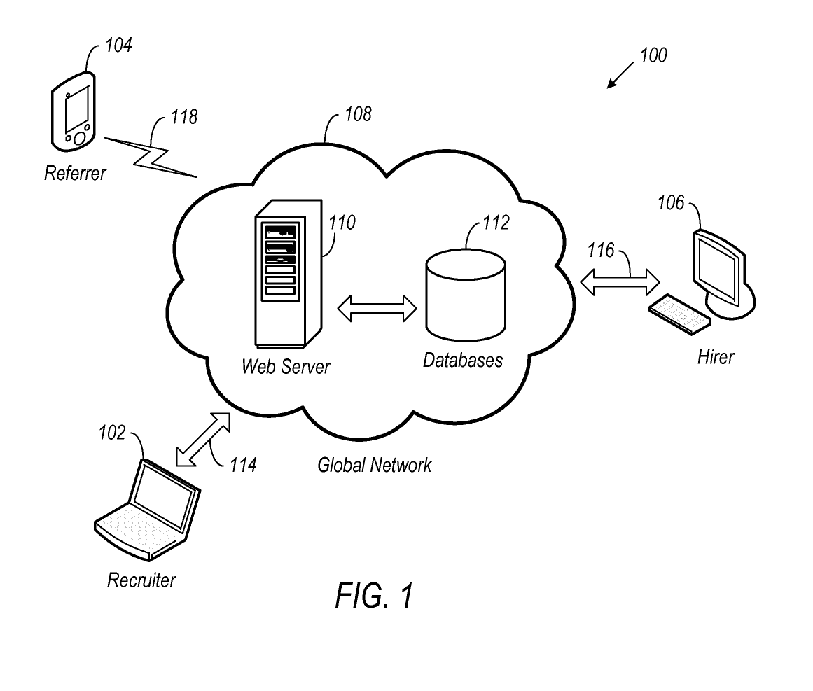

General System Architecture: Turning now to the drawings and, in particular, to FIG. 1, a system 100 according to the disclosed embodiments is shown. As can be seen, the system 100 includes a plurality of computing devices 102, 104, 106 connected to a computing network 108 having at least one Web server 110 and one or more databases 112 connected thereto. In the example shown, the computing devices 102, 104, 106 represent a recruiter, referrer, and hirer, respectively, although the particular sequence as far as which computing device represents which recruitment process participant may vary. Although not expressly shown, employment candidates may also connect to the computing network 108 and the at least one Web server 110. Here, the computing devices 102, 104, 106 are, respectively, a laptop computer, mobile computing device (e.g., iPhone™, BlackBerry™ Droid™, etc.), and personal computer, and the network connections are, respectively, broadband (e.g., cable, DSL, etc.), wireless (e.g., WiFi, GPRS, EDGE, 3G, 4G, etc.), and high-speed broadband (e.g., T1, T3, etc.). Of course, those having ordinary skill in the art will recognize that the types of computing devices and the network connections they use may vary without departing from the scope of the disclosed embodiments. The main requirement of the computing devices 102, 104, 106 is that they have sufficient processing power to run a Web browser thereon.

Referring still to FIG. 1, the computing network 108 may be a private network such as a corporate intranet, or it may be a public network such as the Internet. The at least one Web server 110 and the one or more databases 112 that are connected to the computing network 108 may reside in the same physical location or in physically separate locations, depending on the constraints (e.g., size, speed, etc.) of the particular implementation. In the present example, the at least one Web server 110 may be a server that is capable of hosting a Web-based application over the computing network 108, and the one or more databases 112 may be relational databases, operational databases, or other suitable databases capable of storing data for the Web-based application. The Web-based application, in accordance with the disclosed embodiments, is a recruitment management tool for allowing participants in the recruitment process (i.e., recruiters, referrers, and hirers) to interact with one another in an organized and structured manner, and for allowing participants to be scored or rated based on their performance with respect to one or more predefined criteria, as described later herein.

In general operation, each of the participants may access the computing network 108 using one of the computing devices 102, 104, 106 by entering the URL of the at least one Web server 110 into the Web browser on his/her computing device. Once connected to the at least one Web server 110, the participants may log in to the Web-based recruitment management tool thereon and participate in the recruitment process. Hirers, for example, may post job openings, negotiate fees with recruiters, review resumes, schedule interviews with candidates, make job offers, and the like. If the hirer is a supervisor in his/her company, the hirer may also view and track how other hirers under the supervision of that hirer are performing. Recruiters may view the job openings that have been posted, negotiate fees with hirers, submit candidates to hirers, request candidates from referrers, track submitted candidates, and so forth. In a similar manner, referrers may view the job openings that have been posted, submit candidates to hirers, track submitted candidates, and the like. And candidates may stay informed and obtain updates on the progress of their resumes throughout the recruitment process, and may also withdraw their resumes from the process at any time should they so choose. Finally, recruiters, referrers, and hirers alike may view each other's FPI and determine whether to work with that individual based on his/her past performance. The FPI for each recruiter, referrer, and hirer is calculated and accumulated automatically by the Web-based recruitment management tool from points earned by them in connection with a recruiting event, which points are also awarded (or deducted) automatically by the recruitment management tool. The points and resulting FPI for the recruiters, referrers, and hirers, along with information about the completed and pending recruiting events for each recruiter, referrer, and hirer, as well as information about their job postings and candidates, are maintained in the one or more databases 112.

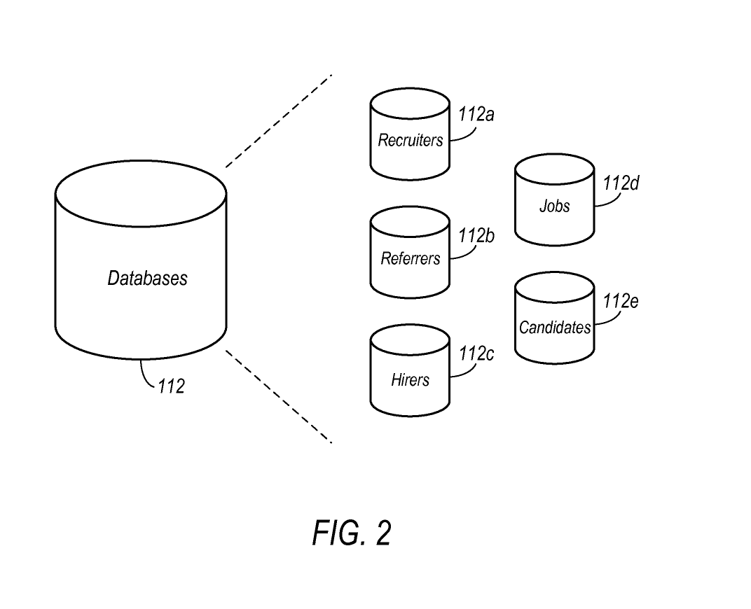

FIG. 2 illustrates an exemplary implementation of the one or more databases 112 connected to the at least one Web server 110 on the computing network 108. As can be seen, the exemplary one or more databases 112 may include a recruiter database 112a, referrer database 112b, hirer database 112c, jobs database 112d, and candidates database 112e. Each database 112a-e may store information about the subject named in that database pertaining to the recruitment process. For example, the recruiter database 112a may store information about recruiters, including relevant contact information (e.g., name, telephone number, company or firm name, e-mail address etc.). The recruiter database 112a may also store information about where the recruiter is in the recruitment process, the points each recruiter has earned, the total number of events completed, and his/her resulting FPI. Similar information may be stored about referrers and hirers in the referrer database 112b and the hirer database 112c, respectively. Likewise, information about the jobs that have been posted, such as company name, location, position, responsibilities, salary range, and the like, may be stored in the jobs database 112d. Lastly, information pertaining to the candidates, including names, education, experience, and resumes, and the like, may be stored in the candidates database 112e. Of course, those having ordinary skill in the art will understand that instead of the multiple databases depicted, a single database 112 may also be used, or additional databases may be added to the ones shown, without departing from the scope of the disclosed embodiments. In any event, the information in these databases 112a-e may then be accessed by the at least one Web server 110 as needed to operate the Web-based recruitment management tool.

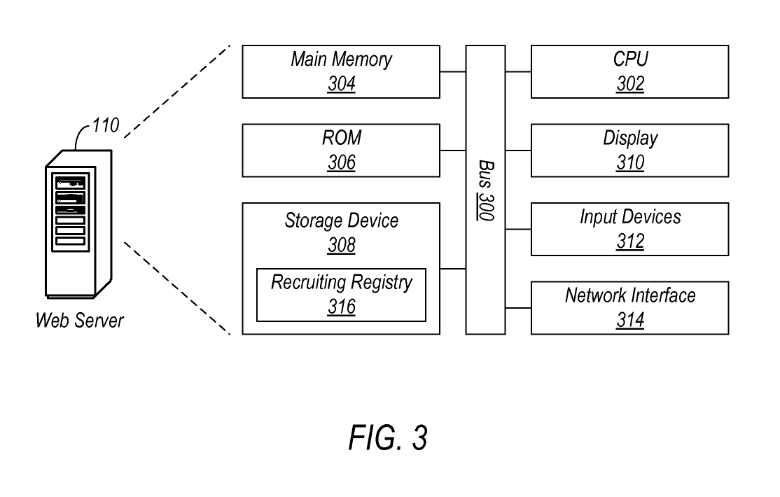

FIG. 3 illustrates an exemplary Web server that may be used as one of the at least one Web server 110 on the computing network 108. This Web server 110 may be any suitable computing system known to those having ordinary skill in the art, including a high-end personal computer, workstation, main frame, and the like, running Windows Server, Mac OS X Server, Linux, FreeBSD, Solaris, Unix, z/OS, and the like. Such a Web server 110 typically includes a bus 300 or other communication mechanism for transferring information within the Web server 110 and a CPU 302 coupled with the bus 300 for processing the information. The Web server 110 may also include a main memory 304, such as a random access memory (RAM) or other dynamic storage device coupled to the bus 300 for storing computer-readable instructions to be executed by the CPU 302. The main memory 304 may also be used for storing temporary variables or other intermediate information during execution of the instructions to be executed by the CPU 302. The Web server 110 may further include a read only memory (ROM) 306 or other static storage device coupled to the bus 300 for storing static information and instructions for the CPU 302. A computer-readable storage device 308, such as a magnetic disk or optical disk, may be coupled to the bus 300 for storing information and instructions for the CPU 302.

The term “computer-readable instructions” as used above refers to any instructions that may be performed by the CPU 302 and/or other components of the Web server 110. Similarly, the term “computer-readable medium” refers to any non-transitory storage medium that may be used to store the computer-readable instructions. Such a computer-readable medium may take many forms, including, but not limited to, non-volatile media, volatile media, and transmission media, but generally does not include transitory medium (e.g., electrical or optical signals, etc.). Non-volatile media may include, for example, optical or magnetic disks, such as the storage device 308. Volatile media may include dynamic memory, such as main memory 304. Transmission media may include coaxial cables, copper wire and fiber optics, including wires of the bus 300. Transmission itself may take the form of acoustic or light waves, such as those generated during radio frequency (RF) and infrared (IR) data communications. Common forms of computer-readable media may include, for example, a floppy disk, a flexible disk, hard disk, magnetic tape, other magnetic medium, a CD ROM, DVD, other optical medium, a RAM, a PROM, an EPROM, a FLASH EPROM, other memory chip or cartridge, or any other medium from which a computer can read.

The CPU 302 may also be coupled via the bus 300 to a display 310, such as a liquid crystal display (LCD), cathode ray tube (CRT), and the like for displaying information to a user. One or more input devices 312, including alphanumeric and other keyboards, mouse, trackball, cursor direction keys, and so forth, may be coupled to the bus 300 for communicating information and command selections to the CPU 302. A network interface 314 provides two-way data communication between the Web server 110 and other computers over the computing network 108. In one example, the network interface 314 may be an integrated services digital network (ISDN) card or a modem used to provide a data communication connection to a corresponding type of communication line. As another example, the network interface 314 may be a local area network (LAN) card used to provide a data communication connection to a compatible LAN. Wireless links may also be implemented via the network interface 314. In summary, the main function of the network interface 314 is to send and receive electrical, electromagnetic, optical, or other signals that carry digital data streams representing various types of information.

Recruitment Management Tool: In accordance with the disclosed embodiments, a Web-based recruitment management tool 316, or rather the computer-readable instructions therefor, may also reside on the storage device 208. The computer-readable instructions for the recruitment management tool 316 may then be executed by the CPU 202 and/or other components of the Web server 110 make the recruitment management tool 316 available to users who wish to participate in the employment recruitment process. As mentioned above, the recruitment management tool 316 divides the recruitment process into a series of predefined actions or steps, thereby imposing or enforcing a standardized and uniform process for the various participants in the process. This recruitment management tool 316 may be implemented using any suitable application development environment and programming language known to those having ordinary skill in the art, including, but not limited to, Microsoft Silverlight, Cocoa Framework from Apple, Inc., and similar programming environments, and programming languages like C++. As for the data created and used by the recruitment management tool 316, this data may be stored in the one or more databases 112, which may also reside on the storage device 208, or they may reside in a physically separate location from the Web server 110 (as shown here).

In general operation, in one implementation, the recruitment management tool 316 allows users to log in to the tool and perform various actions and steps related to the recruitment process. As each action or step is performed, the recruitment management tool 316 automatically awards points to or deducts points from the user based on one or more objective criteria pertaining to that action or step, such as response time and the like. The recruitment management tool 316 also automatically notifies the user when an action or step needs to be taken as a result of another user completing a preceding or prerequisite action or step. The notifications are preferably provided using internal system messages, but may also be sent through standard e-mail messages, text messages, voicemail messages, and/or the like. In some configurations, the recruitment management tool 316 may also implement one or more communication protocols that allow users to manually initiate communication with each other. Examples of such protocols may include the above mentioned e-mail messages, text messages, and voicemail messages, as well as audio and/or video conferencing (e.g., VoIP, SKYPE, etc.). This provides a one-stop solution for hirers, recruiters, referrers, and employment candidates to carry out their recruitment related communications. For example, hirers may conduct telephone and/or video conference interviews with candidates entirely through the recruitment management tool 316. Such a recruitment management tool 316 may be offered as an online service, either free of charge (i.e., advertisement-driven service) or as a fee-based service where the service provider retains a certain percentage of all fees paid to the recruiters and referrers by the hirers. It is also possible to offer the recruitment management tool 316 as a subscription-based service where the user pays a monthly fee, either fixed or use-based, to access and use the tool. Various combinations of the above arrangements are all within the scope of those having ordinary skill in the art. Following is a description of an exemplary implementation of the recruitment management tool 316 according to the disclosed embodiments.

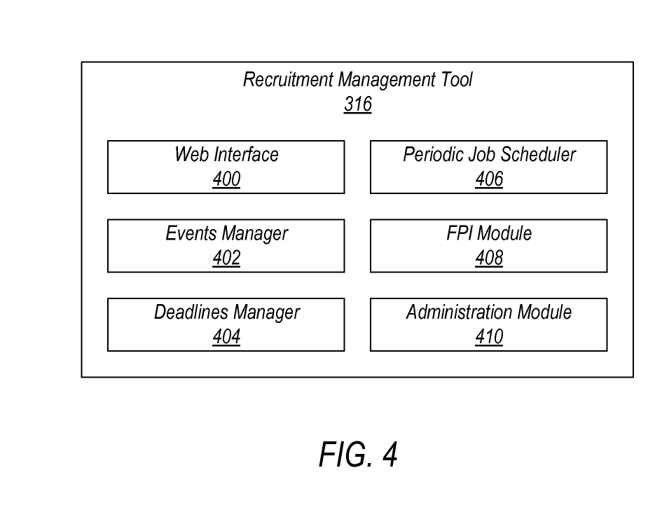

Referring now to FIG. 4, in one exemplary implementation, the Web-based recruitment management tool 316 may comprise a number of functional components, shown here as discrete modules. Of course, those having ordinary skill in the art will understand that throughout this disclosure, two or more functional components may be combined into a single component, and any individual functional component may be divided into several constituent components, without departing from the disclosed embodiments. These functional components may operate in conjunction with one another, each module being able to invoke and transfer data to and from one or more other modules as needed to provide the overall functionality as well as look-and-feel of the recruitment management tool 316.

As can be seen in the implementation of FIG. 4, the functional components of the recruitment management tool 316 may include a Web interface module 400, an events manager module 402, a deadlines manager module 404, a periodic job scheduler module 406, an FPI module 408, and an administration module 410. Those having ordinary skill in the art will understand, of course, if that the implementation of FIG. 4 is exemplary only, and that various other ways of implementing the recruitment management tool 316 using various other modules (or no modules) may be derived by those having ordinary skill in the art without departing from the principles and teaching of the present disclosure.

In general, the Web interface module 400 provides a graphical user interface that participants may use via a Web browser to interact with the recruitment management tool 316. As those skilled in the art understand, such a graphical user interface may be provided by transmitting an HTML representation of the graphical user interface from the at least one Web server 110 to the Web browser of the participant's computing device. It is also possible, of course, to provide other, non-HTML representations of the graphical user interface without departing from the scope of the disclosed embodiments.

The events manager 402 controls, among other things, the sequencing of the various actions or steps that are involved in the recruitment process. In particular, when a participant completes an action or step, such as a job posting, a candidate submission, and the like, the events manager 402 determines which action(s) or step(s) are available to be performed next and by which participant. The events manager 402 then offers only these action(s) or step(s) as options from which that participant may choose (via the graphical user interface). Thus, for example, when a hirer has completed a job posting, the next available action(s) or step(s) that the events manager 402 may determine that the next action or step should be the hirer sending a candidate search proposal to a specific recruiter, or the hirer requesting candidates from multiple recruiters, and so forth. This arrangement results in a standardized and uniform recruitment process, such that certain actions or steps are always taken in a certain order. As one example, the action or step of submitting a candidate can only occur after recruiting fee negotiations have been completed and not beforehand. Likewise, a recruiting fee may only be negotiated after a specific job posting has been completed and not beforehand, and the like.

The deadlines manager 404 operates, among other things, to monitor and record the various deadlines that the participant has met, via the graphical user interface, for each recruiting event completed by the participant. Recall that a recruiting event is an action or step that may result in points being awarded to or deducted from a participant. For a given recruiting event, the deadlines manager 404 may determine, in real time via the graphical user interface, whether the participant has met a first deadline (e.g., seven days), a second deadline (e.g., 14 days) if available, or a third deadline (e.g., 30 days) if available, or whether the participant has failed to meet any deadline. In accordance with the disclosed embodiments, the deadlines manager 404 may determine whether the participant has met these deadlines using one or more objective criteria. For example, did the recruiter respond to a fee proposal by or within a given deadline. As another example, did the recruiter provide the agreed-upon number of employment candidates by or within a given deadline, and so on. The deadlines manager 404 may thereafter award points to or deduct points from each participant based on whether the participant satisfied the objective criterion for a the deadline, and record the points information for that participant in the appropriate database 112a-e.

Note that certain recruiting events may have multiple objective criteria associated therewith and thus multiple opportunities for points. For example, where an event involves a search assignment, recruiters are typically required to submit a certain number of candidates to hirers within a certain time period. In such an event, the recruiter may receive a first number of points for submitting one candidate within the given time period, a second number of points for submitting two candidates within the given time period, a third number of points for submitting three candidates within the given time period, and so forth. Alternatively, if the agreed-upon number of candidates to be submitted is three, the recruiter may have a first number of points deducted if he/she submits only two candidates, and a second (larger) number of points deducted if he/she submits only one candidate, and so on. It is also possible instead to award the recruiter proportionately fewer points than the maximum number of available points for introducing fewer than the agreed-upon number of candidates.

The points earned by a participant and any other information needed to calculate the Performance Percentage for the participant may be extracted by the periodic job scheduler 406. In one implementation, the periodic job scheduler 406 may operate to scan the databases 112a-e on a regular or periodic basis to acquire the number of points awarded to, or deducted from, a participant for a recently completed recruiting event. The periodic job scheduler 406 may thereafter forward this information to the FPI module 408 for calculating the Performance Percentage of the participant. The frequency with which the periodic job scheduler 406 performs this extraction may vary and may be set as needed based on the requirements of the specific implementation, but should generally be high enough so that there is not a noticeable lag between the time a recruiting event is completed and the time the Performance Percentage, and hence the FPI, for a participant is updated. It is also possible in some embodiments to have the job scheduler 406 extract information from the databases 112a-d in real time, for example, as soon as the databases are updated with new information.

The FPI module 408 is primarily responsible for maintaining a history and a running total for the points accumulated by the participants in the recruitment process, and also for calculating the Performance Percentage for the participants. The history may include every recruiting event that has resulted in points awarded to or deducted from the participant, and the running total is the number of points he/she has accumulated over the course of the history. As mentioned above, for a given recruiting event, information concerning the points awarded to or deducted from a participant may be obtained from the periodic job scheduler 406. The FPI module 408 may use this information along with the running total it maintains for each participant to calculate the Performance Percentage. In one implementation, the FPI module 408 may calculate the Performance Percentage as follows:

$$Performance Percentage = \frac{current point total - minimum point total}{maximum point total - minimum point total}$$

In the above calculation, the current point total is the number of points the participant has earned for all completed recruiting events, and the minimum and maximum point totals refer to the minimum and maximum number of points that could have been earned for all recruiting events completed by the participant. Of course, those having ordinary skill in the art will understand that other methods of calculating the Performance Percentage may be used without departing from the scope of the disclosed embodiments.

Finally, the administration module 410, as the name implies, allows certain participants to have administrative privileges over other participants who are using the Web-based recruitment management tool 316. In one implementation, the administration module 410 allows supervisory hirers and recruiters to view the accounts, including the FPI, of the hirers and recruiters working under them in order to see how these subordinates are performing with respect to the recruitment process as well as to monitor their workloads. The administration module 410 may also allow the supervisory hirers and recruiters to take action on behalf of their subordinates, which may be useful in situations where a deadline is about to be missed and the subordinates are unavailable or otherwise occupied. Such an arrangement helps supervisory recruiters and hirers manage their teams more efficiently and effectively.

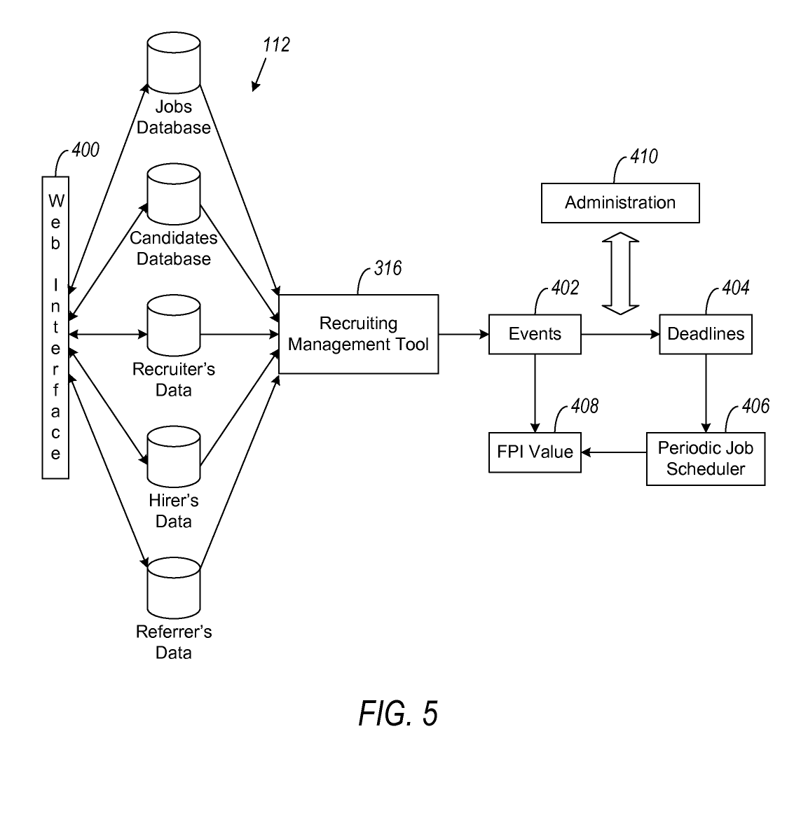

FIG. 5 illustrates the relationship and interaction between the various modules 400-410 of the Web-based recruitment management tool 316 as described in FIG. 4. As can be seen, the Web interface 400 allows participants in the recruitment process to interact with the recruitment management tool 316. Data generated, information provided, and actions taken by the participants with respect to the various actions or steps in the recruitment process via the Web interface 400 is recorded in the appropriate one of the one or more databases 112. Such data, information, and actions taken may then be accessed by the recruitment management tool 316 as needed. Specifically, the data, information, and actions taken may be used by the events manager 402 to manage the sequencing of the various actions or steps in the recruitment process. The deadlines manager 404 may, in turn, monitor the various actions or steps controlled by the events manager 402 to determine whether any points should be awarded to or deducted from the participants. The periodic job scheduler 406 thereafter extracts the points information and provides it to the FPI module 408. The FPI module 408 subsequently uses this points information to update the FPI calculations and histories for the various participants accordingly.

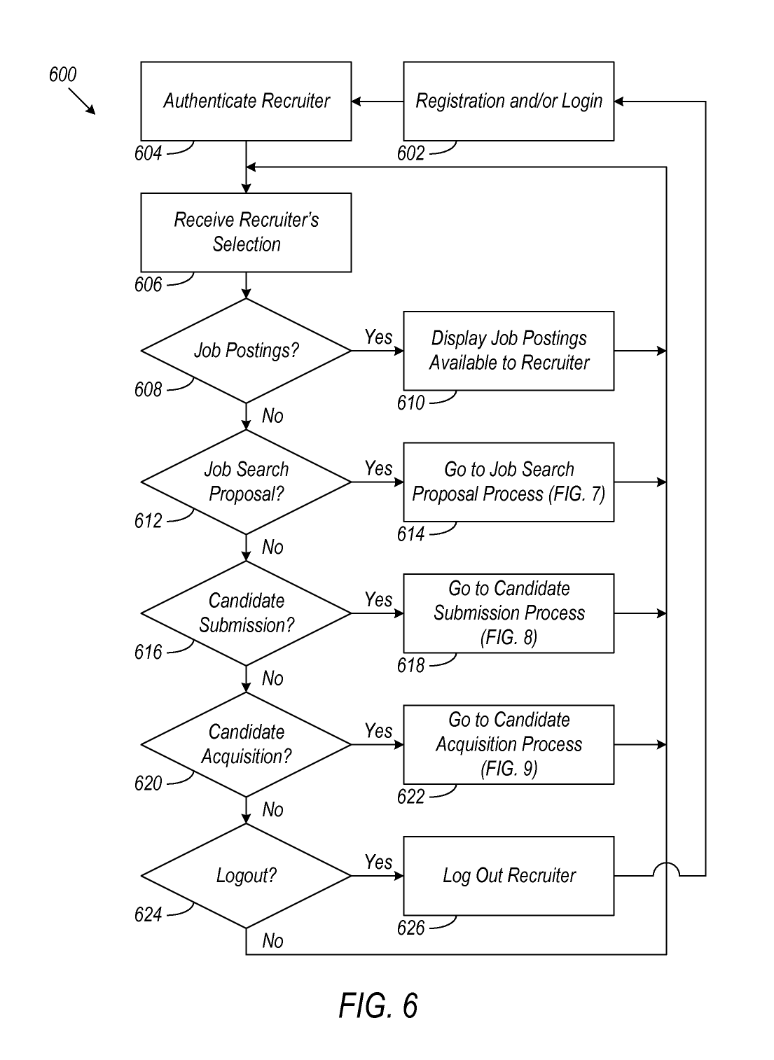

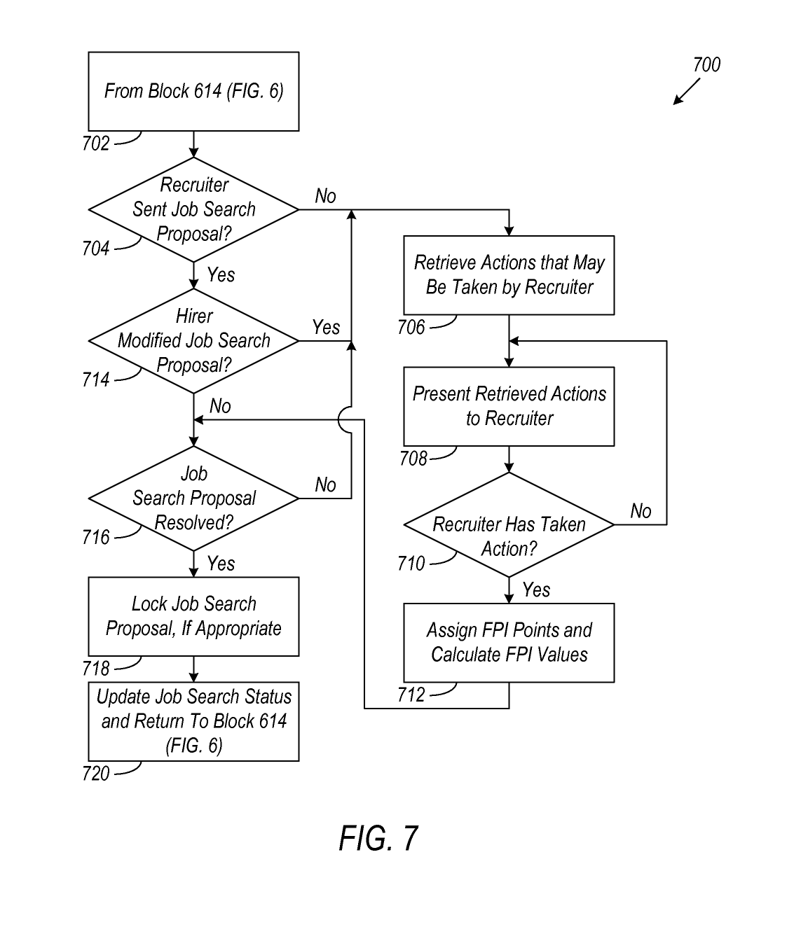

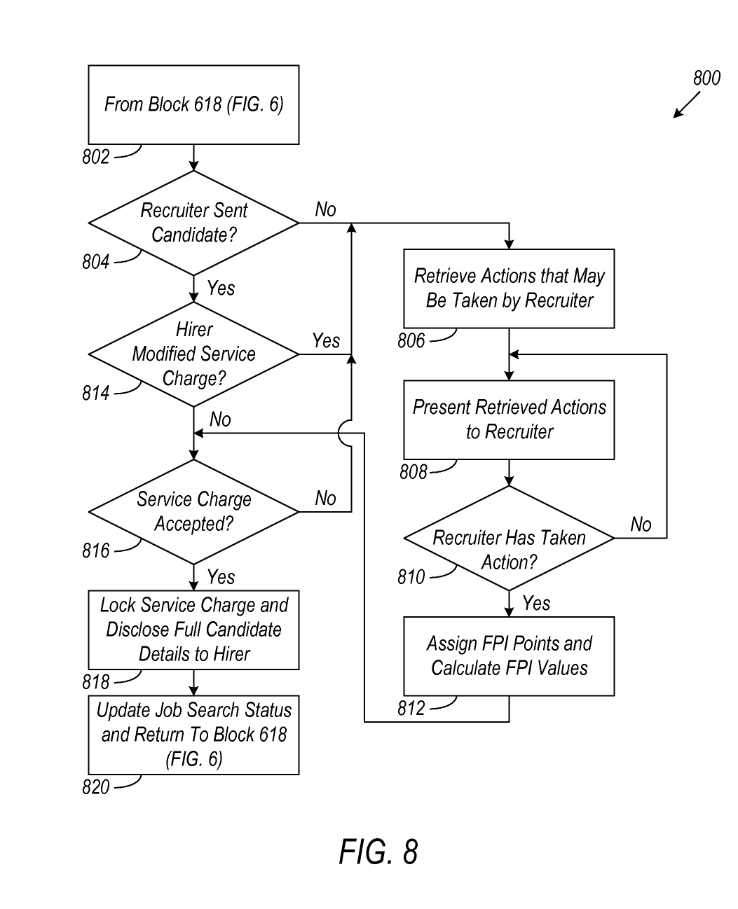

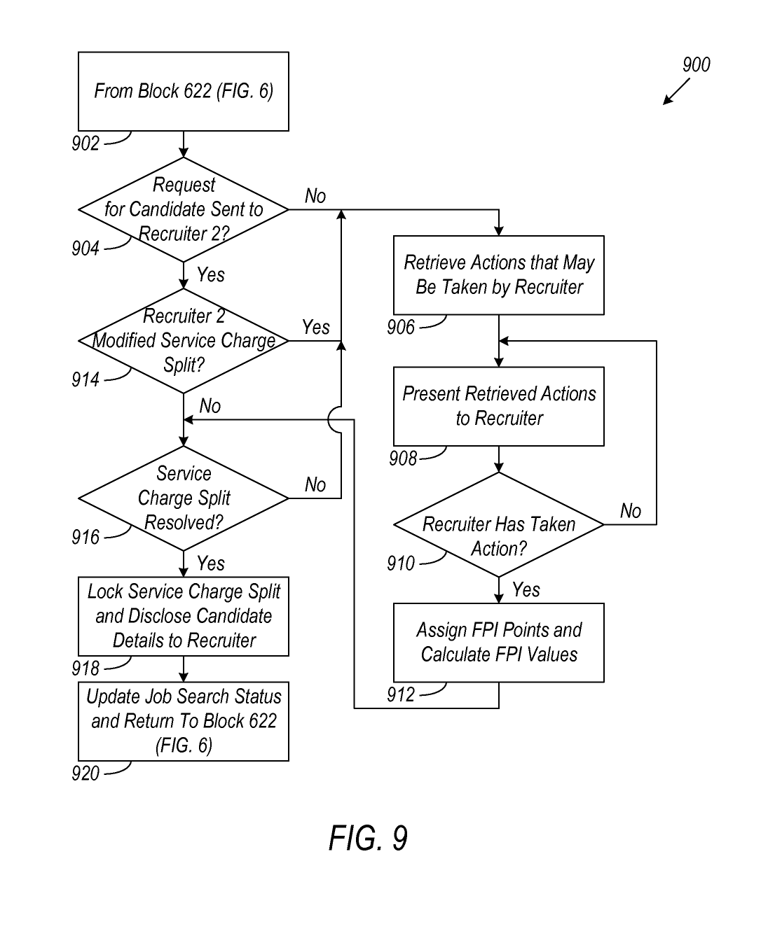

General Operation: General operation of the Web-based recruitment management tool 316 is illustrated in FIGS. 6-15 from the perspective of a recruiter, a referrer, and a hirer at a high level via exemplary flowcharts. The flowcharts depict, at a high level, an exemplary method of managing and tracking the activities of recruiters, referrers, and hirers in the employment recruiting process, and of automatically and objectively scoring or rating the performance of these recruiters, referrers, and hirers. It should be emphasized that the exemplary flowcharts shown in FIGS. 6-15 by no means illustrate each and every possible implementation of the Web-based recruitment management tool 316. Note further that although the steps of the flowcharts are shown in discrete blocks throughout FIGS. 6-15, those having ordinary skill in the art will understand that two or more blocks may be combined into a single block, and that any individual block may be divided into several constituent blocks, without departing from the disclosed embodiments. In addition, although the blocks of the flowcharts have been arranged in a particular sequence, those having ordinary skill in the art will understand that one or more blocks may be rearranged in a different sequence without departing from the scope of the disclosed embodiments.

Referring first to FIG. 6, a flow chart 600 illustrates the operation of the Web-based recruitment management tool 316 from the perspective of a user who is a recruiter. The flowchart 600 begins at block 602, where the recruiter logs in to the recruitment management tool 316, or is otherwise given an opportunity to register with the recruitment management tool 316 if he/she does not already have an account. At block 604, the recruiter is authenticated for security purposes and, if confirmed, allowed to access the recruitment management tool 316. At block 606, the recruiter is presented with a plurality of choices and options from which he/she may select. Upon receiving the recruiter's selection, a determination is made at block 608 as to whether the recruiter has opted to view job postings. If yes, then those job postings that are available for viewing by the recruiter may be displayed at block 610.

If no, then the flowchart 600 proceeds to block 612, where a determination is made as to whether the recruiter has opted to work on a job search proposal. If yes, then the flowchart 600 proceeds to the recruiter's job search proposal process at block 614. If no, then at block 616, a determination is made as to whether the recruiter has opted to work on submission of an employment candidate for one of the job searches for which he has been engaged. If yes, then the flowchart proceeds to the recruiter's candidate submission process at block 618. If no, then a determination is made as to whether the recruiter wishes to acquire candidates for one of the job searches for which he has been engaged. If yes, then the flowchart 600 proceeds to the recruiter's candidate acquisition process at block 622. If no, then a determination is made as to whether the recruiter has logged out of the Web-based recruitment management tool 316. If yes, then the recruiter is logged out, and the flowchart returns to the login and/or registration process at block 602. Otherwise, the flowchart 600 returns to block 606 and awaits the recruiter's next selection.

FIG. 7 is a flow chart 700 showing the job search proposal process from block 614 of FIG. 6 in more detail. As can be seen, the flowchart 700 begins at block 702, where the recruiter enters the job search proposal process. At block 704, a determination is made as to whether the recruiter has already sent a job search proposal to the hirer for a particular job posting. If no, then the flowchart 700 retrieves the actions that are available to be taken by the recruiter at block 706, and presents these actions to the recruiter at block 708. At block 710, a determination is made as to whether the recruiter has taken an action. If yes, then points are awarded or deducted accordingly based on the specific action taken and when it was taken at block 712, and the FPI for the recruiter is calculated and updated accordingly. An example of an action that may be taken by the recruiter at this point is sending a job search proposal to the hirer. The flowchart 700 thereafter proceeds to block 716, where a determination is made as to whether the job search proposal has been resolved with the hirer. If no, then the flowchart 700 returns to block 706 to retrieve the actions that may be taken by the recruiter at this point, and the process continues as described above. If yes, then the job search proposal is locked, if appropriate, at block 718, and the status of this particular job search is updated at block 720. The flowchart 700 thereafter returns to block 614 of FIG. 6.

If the determination at block 704 above produces an affirmative answer, then the flowchart 700 proceeds to block 714, where a determination is made as to whether the hirer has modified the job search proposal. If yes, then the flowchart 700 returns to block 706 to retrieve the actions that may be taken by the recruiter at this point, and the process continues as described above. If no, then the flowchart proceeds to block 716 to determine whether the job search proposal has been resolved with the hirer, and the process proceeds as described earlier. In some scenarios, the resolution of the job search proposal at block 716 results in the two sides deciding not to work with each other, in which case the flowchart 700 simply updates the job search status and returns to block 614 of FIG. 6.

FIG. 8 illustrates a flow chart 800 showing the candidate submission process from block 618 of FIG. 6 in more detail. The flowchart 800 is similar to the flowchart 700 of FIG. 7, except that instead of a job search proposal, the flowchart involves submitting an employment candidate to the hirer. As can be seen, the flowchart 800 begins at block 802, where the recruiter enters the candidate submission process. At block 804, a determination is made as to whether the recruiter has already sent an employment candidate to the hirer for a particular job posting. If no, then the flowchart 800 retrieves the actions that are available to be taken by the recruiter at block 806, and presents these actions to the recruiter at block 808. At block 810, a determination is made as to whether the recruiter has taken an action. If yes, then points are awarded or deducted accordingly based on the specific action taken and when it was taken at block 812, and the FPI for the recruiter is calculated and updated accordingly. An example of an action that may be taken by the recruiter at this point is sending an employment candidate to the hirer. The flowchart 800 thereafter proceeds to block 816, where a determination is made as to whether the service charge for the candidate has been resolved with the hirer. If no, then the flowchart 800 returns to block 806 to retrieve the actions that may be taken by the recruiter at this point, and the process continues as described above. If yes, then the service charge is locked, when appropriate, at block 818, and the full details (e.g., full resume) of the employment candidate is revealed to the hirer. In general, for all participants throughout the recruitment process, it is understood that recruiters and referrers may withhold the full details of a given employment candidate, and reveal only a portion of the details, until such time after a service fee has been negotiated for the candidate. When this is done, the status of this particular job search is updated at block 820, and the flowchart 800 thereafter returns to block 618 of FIG. 6.

If the determination at block 804 above produces an affirmative answer, then the flowchart 800 proceeds to block 814, where a determination is made as to whether the hirer has modified the service charge for this job posting. If yes, then the flowchart 800 returns to block 806 to retrieve the actions that may be taken by the recruiter at this point, and the process continues as described above. If no, then the flowchart proceeds to block 816 to determine whether the service charge has been resolved with the hirer, and the process proceeds as described earlier. In some scenarios, the resolution of the service charge at block 816 results in the two sides deciding not to work with each other, in which case the flowchart 800 simply updates the job search status and returns to block 618 of FIG. 6.

FIG. 9 is a flow chart 900 showing the candidate acquisition process from block 622 of FIG. 6 in more detail. The flowchart 900 is similar to the flowchart 800 of FIG. 8, except that instead of submitting an employment candidate to the hirer, the flowchart involves acquiring a candidate from a second recruiter, referred to in the flowchart as recruiter 2. As can be seen, the flowchart 900 begins at block 902, where the first recruiter enters the candidate acquisition process. At block 904, a determination is made as to whether the first recruiter has already sent a request for a candidate to recruiter 2 for a particular job posting. If no, then the flowchart 900 retrieves the actions that are available to be taken by the first recruiter at block 906, and presents these actions to the first recruiter at block 908. At block 910, a determination is made as to whether the first recruiter has taken an action. If yes, then points are awarded or deducted accordingly based on the specific action taken and when it was taken at block 912, and the FPI for the first recruiter is calculated and updated accordingly. An example of an action that may be taken by the first recruiter at this point is sending a request for an employment candidate to recruiter 2. The flowchart 900 thereafter proceeds to block 916, where a determination is made as to whether the service charge split for the candidate has been resolved with recruiter 2. If no, then the flowchart 900 returns to block 906 to retrieve the actions that may be taken by the first recruiter at this point, and the process continues as described above. If yes, then the service charge split is locked, if appropriate, at block 918, and the full details (e.g., full resume) of the employment candidate is revealed to the first recruiter. The status of this particular job search is then updated at block 920, and the flowchart 900 thereafter returns to block 618 of FIG. 6.

If the determination at block 904 above produces an affirmative answer, then the flowchart 900 proceeds to block 914, where a determination is made as to whether recruiter 2 has modified the service charge split for this job posting. If yes, then the flowchart 900 returns to block 906 to retrieve the actions that may be taken by the first recruiter at this point, and the process continues as described above. If no, then the flowchart proceeds to block 916 to determine whether recruiter 2 has resolved the service charge split, and the process proceeds as described earlier. In some scenarios, the resolution of the service charge split at block 916 results in the two sides deciding not to work with each other, in which case the flowchart 900 simply updates the job search status and returns to block 622 of FIG. 6.

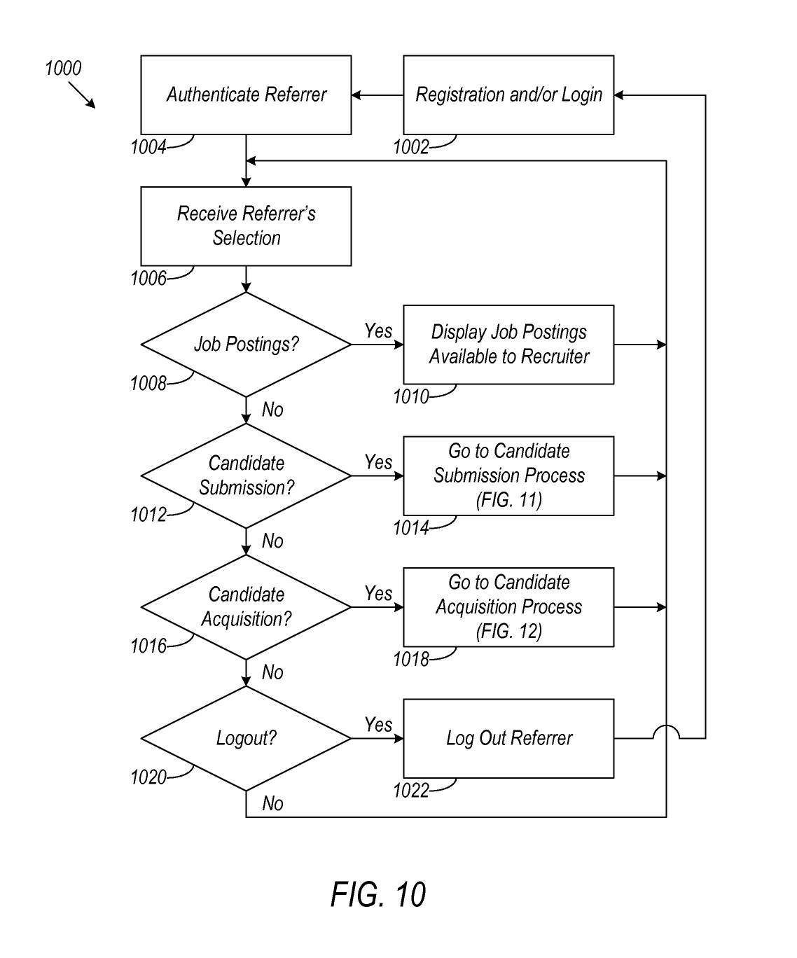

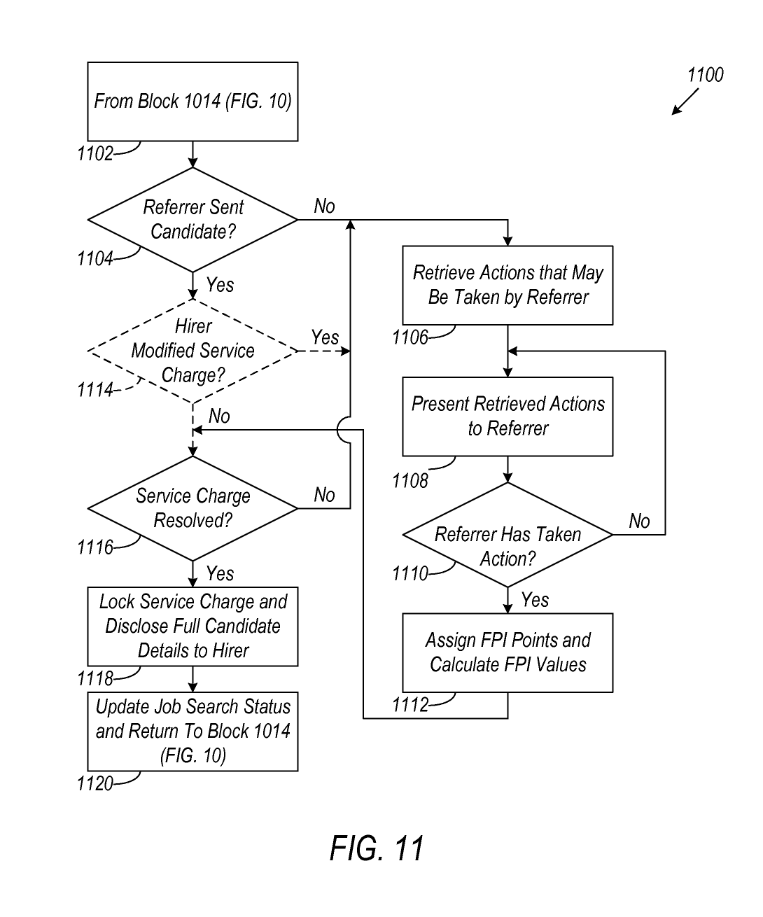

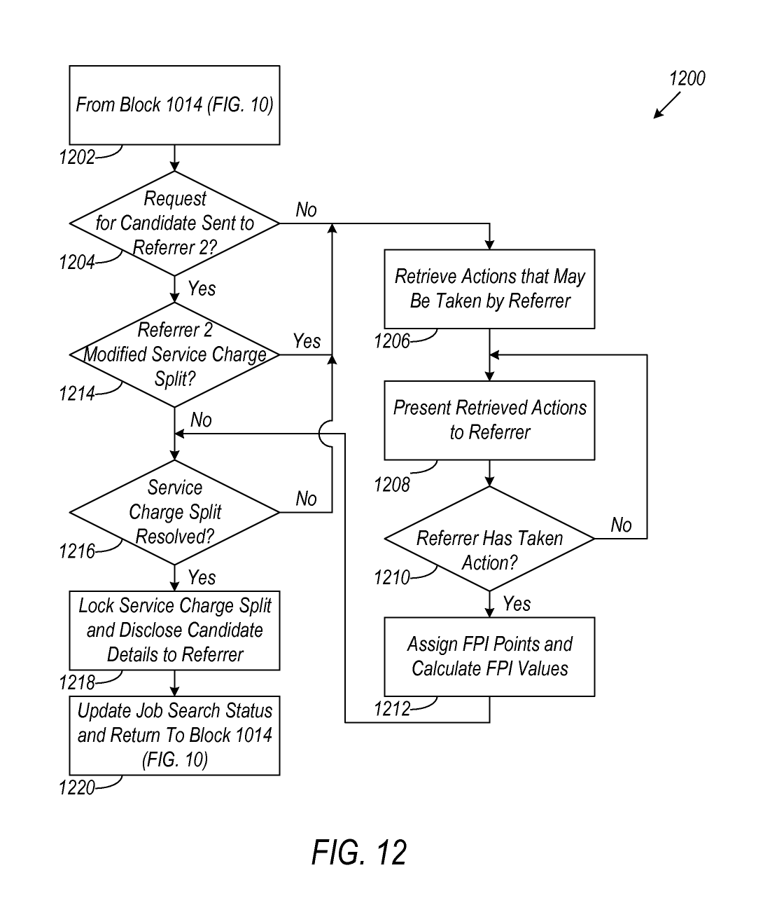

FIG. 10 illustrates a flowchart 1000 that depicts the operation of the Web-based recruitment management tool 316 from the perspective of a user who is a referrer. The flowchart 1000 includes a plurality of blocks 1002 through 1022 that are similar to their functional counterparts in the flowchart 600 of FIG. 6, the exception being that there is no job search proposal process because referrers typically do not have the option to propose a job search to hirers. The flowcharts 1000 and 600 are otherwise similar and therefore, for economy of the description, the reader is referred to the description of the flowchart 600 for a detailed understanding of the flowchart 1000.

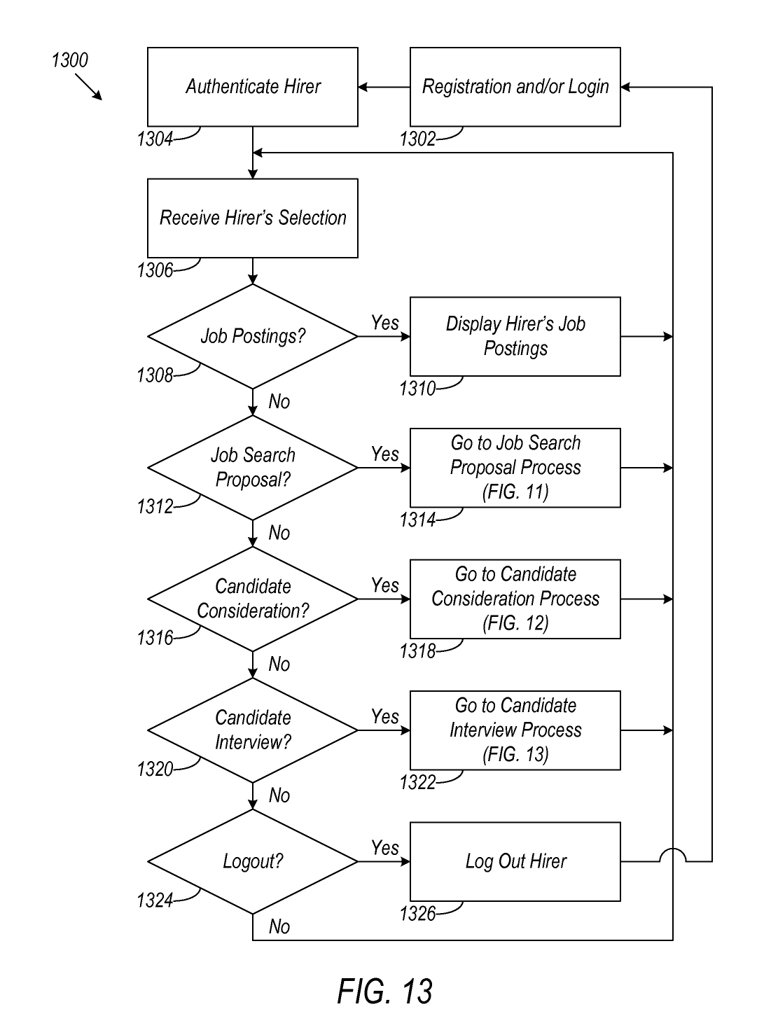

FIG. 11 illustrates a flow chart 1100 showing the candidate submission process from block 1014 of FIG. 10 in more detail. The flowchart 1100 includes a plurality of blocks 1102 through 1120 that are similar to their functional counterparts in the flowchart 800 of FIG. 8. Depending on the implementation, however, there may or may not be a block 1114 for determining whether the hirer has modified the service charge, as referrers typically do not have the option to negotiate a service charge with hirers. Block 1114 is therefore shown in dashed lines to indicate that the block is optional. The flowcharts 1100 and 800 are otherwise similar and therefore, for economy of the description, the reader is referred to the description of the flowchart 800 for a detailed understanding of the flowchart 1100.

FIG. 12 is a flow chart 1200 that shows the candidate acquisition process from block 1018 of FIG. 10 in more detail. The flowchart 1200 includes a plurality of blocks 1202 through 1220 that are similar to their functional counterparts in the flowchart 900 of FIG. 9. Therefore, for economy of the description, the reader is referred to the description of the flowchart 900 for a detailed understanding of the flowchart 1200.

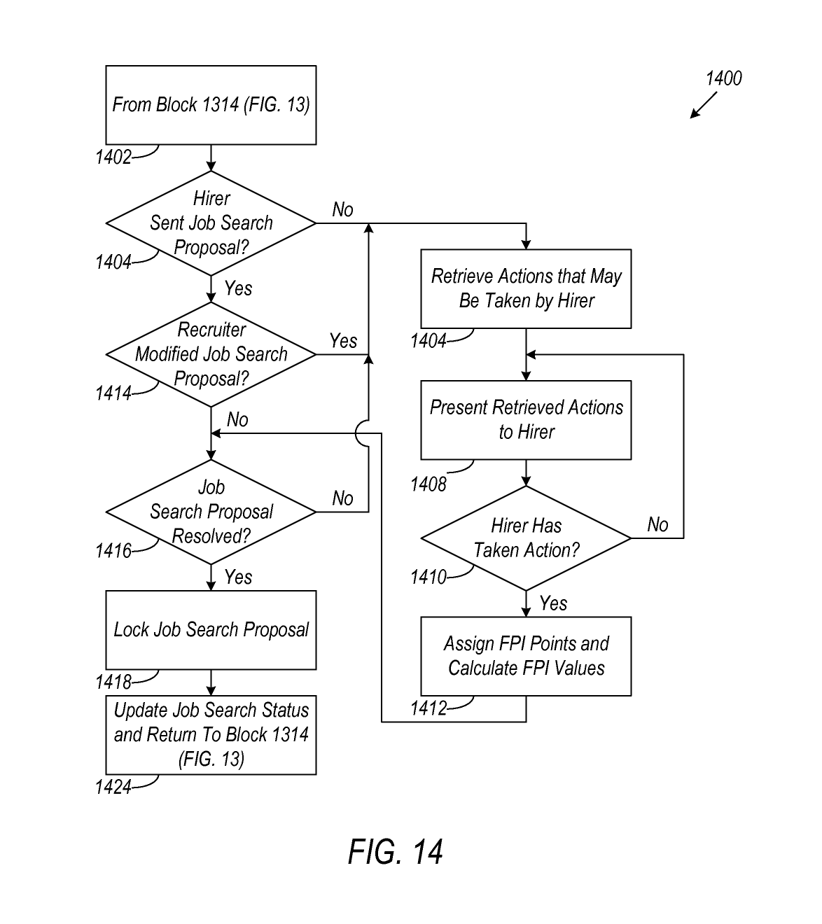

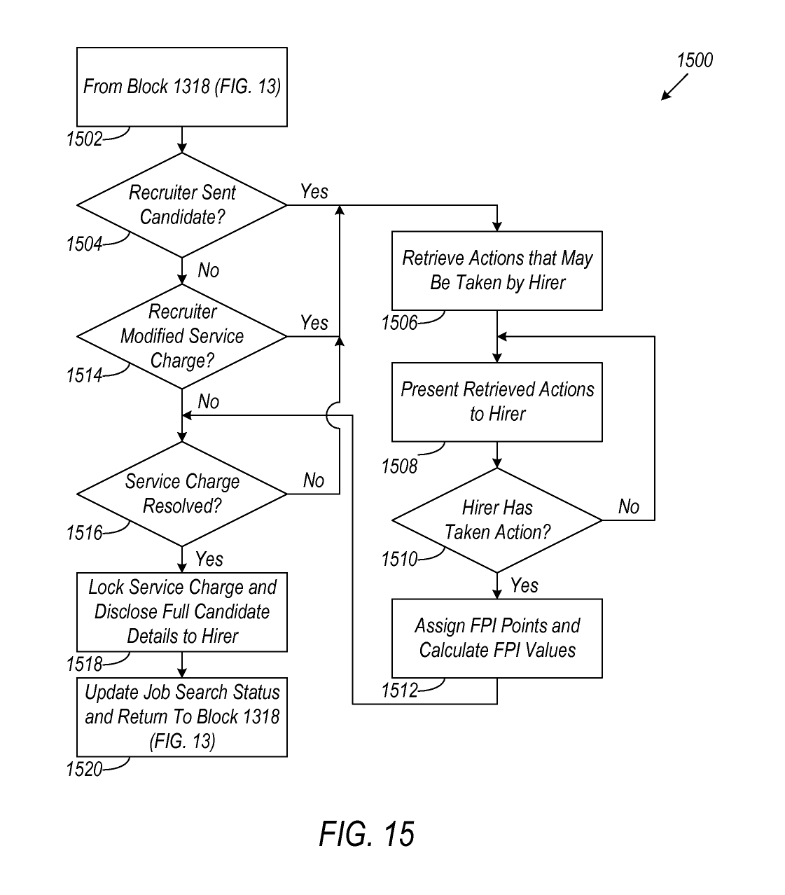

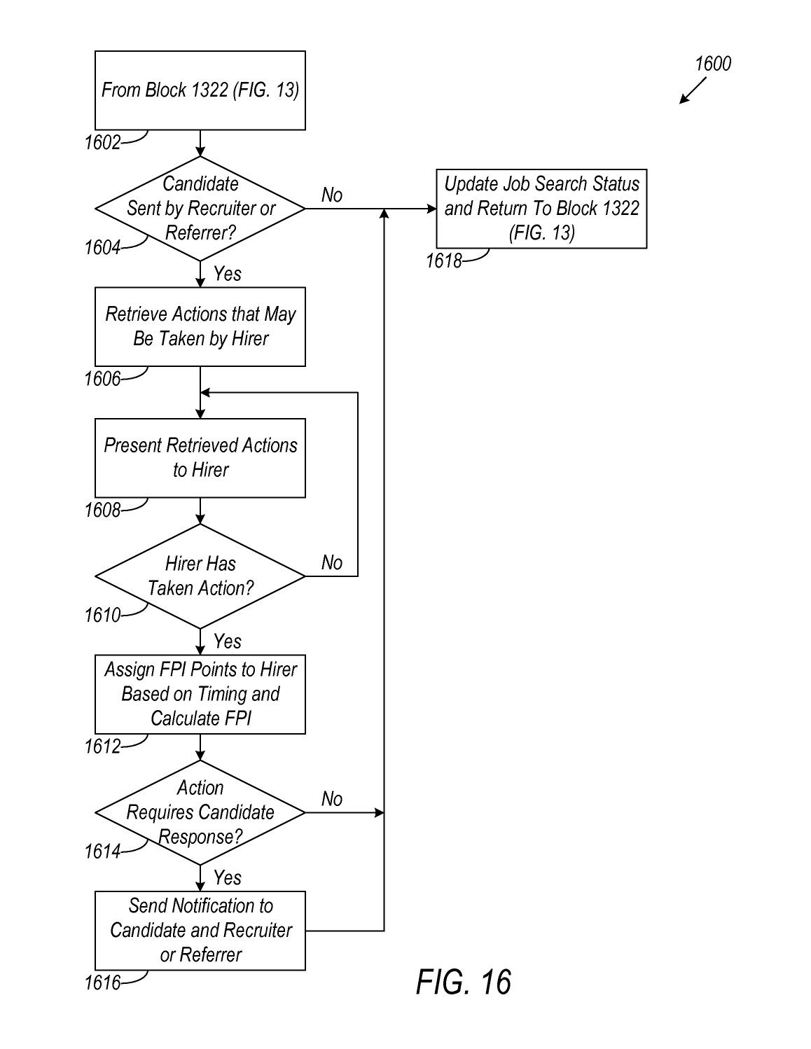

Referring now to FIG. 13, a flow chart 1300 illustrates the operation of the Web-based recruitment management tool 316 from the perspective of a user who is a hirer. The flowchart 1300 begins at block 1302, where the hirer logs in to the recruitment management tool 316, or is otherwise given an opportunity to register with the recruitment management tool 316 if he/she does not already have an account. At block 1304, the hirer is authenticated for security purposes and, if confirmed, allowed to access the recruitment management tool 316. At block 1306, the hirer is presented with a plurality of choices and options from which he/she may select. Upon receiving the hirer's selection, a determination is made at block 1308 as to whether the hirer has opted to view job postings. If yes, then those job postings that were posted by the hirer may be displayed at block 1310.

If no, then the flowchart 1300 proceeds to block 1312, where a determination is made as to whether the hirer has opted to work on a job search proposal. If yes, then the flowchart 1300 proceeds to the hirer's job search proposal process at block 1314. If no, then at block 1316, a determination is made as to whether the hirer has opted to work on considering any of the employment candidates that have been submitted to him/her for consideration. If yes, then the flowchart proceeds to the hirer's candidate submission process at block 1318. If no, then a determination is made as to whether the hirer wishes to interview any of the candidates that have been submitted to him. If yes, then the flowchart 1300 proceeds to the candidate consideration process at block 1322. If no, then a determination is made as to whether the hirer has logged out of the Web-based recruitment management tool 316. If yes, then the hirer is logged out, and the flowchart returns to the login and/or registration process at block 1302. Otherwise, the flowchart 1300 returns to block 1306 and awaits the hirer's next selection.

FIG. 14 is a flow chart 1400 showing the job search proposal process from block 1314 of FIG. 13 in more detail. As can be seen, the flowchart 1400 begins at block 1402, where the hirer enters the job search proposal process. At block 1404, a determination is made as to whether the hirer has already sent a job search proposal to the recruiter (or referrer) for a particular job posting. If no, then the flowchart 1400 retrieves the actions that are available to be taken by the hirer at block 1406, and presents these actions to the hirer at block 1408. At block 1410, a determination is made as to whether the hirer has taken an action. If yes, then points are awarded or deducted accordingly based on the specific action taken and when it was taken at block 1412, and the FPI for the hirer is calculated and updated accordingly. An example of an action that may be taken by the hirer at this point is sending a job search proposal to the recruiter (or referrer). The flowchart 1400 thereafter proceeds to block 1416, where a determination is made as to whether the job search proposal has been resolved with the recruiter. If no, then the flowchart 1400 returns to block 1406 to retrieve the actions that may be taken by the hirer at this point, and the process continues as described above. If yes, then the job search proposal is locked, if appropriate, at block 1418, and the status of this particular job search is updated at block 1420. The flowchart 1400 thereafter returns to block 1314 of FIG. 13.

If the determination at block 1404 above produces an affirmative answer, then the flowchart 1400 proceeds to block 1414, where a determination is made as to whether the recruiter has modified the job search proposal. If yes, then the flowchart 1400 returns to block 1406 to retrieve the actions that may be taken by the hirer at this point, and the process continues as described above. If no, then the flowchart proceeds to block 1416 to determine whether the job search proposal has been resolved with the recruiter, and the process proceeds as described earlier. In some situations, the resolution of the job search proposal at block 1416 results in the two sides deciding not to work with each other, in which case the flowchart 1400 simply updates the job search status and returns to block 1314 of FIG. 13.

FIG. 15 illustrates a flow chart 1500 showing the hirer's candidate consideration process from block 1318 of FIG. 13 in more detail. The flowchart 1500 is similar to the flowchart 1400 of FIG. 14, except that instead of a job search proposal, the flowchart involves consideration of an employment candidate from the recruiter. As can be seen, the flowchart 1500 begins at block 1502, where the hirer enters the candidate consideration process. At block 1504, a determination is made as to whether the recruiter has already sent an employment candidate to the hirer for consideration with respect to a particular job posting. If yes, then the flowchart 1500 retrieves the actions that are available to be taken by the hirer at block 1506, and presents these actions to the hirer at block 1508. At block 1510, a determination is made as to whether the hirer has taken an action. If yes, then points are awarded or deducted accordingly based on the specific action taken and when it was taken at block 1512, and the FPI for the hirer is calculated and updated accordingly. An example of an action that may be taken by the hirer at this point is accepting the service charge. The flowchart 1500 thereafter proceeds to block 1516, where a determination is made as to whether the service charge for the candidate has been resolved with the recruiter. If no, then the flowchart 1500 returns to block 1506 to retrieve the actions that may be taken by the hirer at this point, and the process continues as described above. If yes, then the service charge is locked, if appropriate, at block 1518, and the full details (e.g., full resume) of the employment candidate is revealed to the hirer. The status of this particular job search is updated at block 1520, and the flowchart 1500 thereafter returns to block 1318 of FIG. 13.

If the determination at block 1504 above produces a negative answer, then the flowchart 1500 proceeds to block 1514, where a determination is made as to whether the recruiter has modified the service charge for this job posting. If yes, then the flowchart 1500 returns to block 1506 to retrieve the actions that may be taken by the hirer at this point, and the process continues as described above. If no, then the flowchart proceeds to block 1516 to determine whether the service charge has been resolved with the recruiter, and the process proceeds as described earlier. In some scenarios, the resolution of the service charge at block 1516 results in the two sides deciding not to work with each other, in which case the flowchart 1500 simply updates the job search status and returns to block 1318 of FIG. 13

Although not expressly shown, a flowchart similar to the flowchart 1500 may be followed with respect to candidates received from referrers, except that there is typically no service charge negotiation with referrers so that the determination in block 1514 may be omitted in some cases, depending on the implementation.

FIG. 16 is a flow chart 1600 showing the candidate interview process from block 1322 of FIG. 13 in more detail. As can be seen, the flowchart 1600 begins at block 1602, where the hirer enters the candidate interview process. At block 1604, a determination is made as to whether the hirer has been sent an employment candidate for a particular job posting from either a recruiter or referrer. If yes, then the flowchart 1600 retrieves the actions that are available to be taken by the hirer at block 1606, and presents these actions to the hirer at block 1608. At block 1610, a determination is made as to whether the hirer has taken an action. Example of an action that the hirer may take at this point is extending an invitation for an interview to the candidate. If yes, then points are awarded or deducted accordingly based on the specific action taken and when it was taken at block 1612, and the FPI for the hirer is calculated and updated accordingly. The flowchart 1600 thereafter proceeds to block 1614, where a determination is made as to whether the action taken by the hirer requires a response from the candidate. If yes, then a notification is sent to the candidate as well as the recruiter or referrer to introduce a candidate at block 1616. If no, then the flowchart 1600 proceeds to block 1618, where the status of this particular job search is updated and the flowchart 1600 thereafter returns to block 1322 of FIG. 13. Likewise, if the determination made at block 1604 is negative, then the flowchart 1600 again proceeds to block 1618, where the status of this particular job search is updated and the flowchart 1600 thereafter returns to block 1322 of FIG. 13.

Following now are several specific examples, in table format, of the principles and teachings described above with respect to the Web-based recruitment management tool 316. In the tables, the column labeled “ACTION” represents the action that was just completed and from which the next actions are determined. The column labeled “NEXT STEP” indicates who needs to take the next action followed by a list of one or more actions that are available to be taken based on the completed action in the “ACTION” column. The column labeled “POINTS TO” identifies the participant to whom points are either awarded or deducted. The column labeled “DEADLINES” represents the time period in which the next action must be taken. Finally, the column labeled “POINTS” indicates the number of points to be awarded or deducted, where the variables A, B, C, D, and E may represent any suitable point scheme (e.g., A=2, B=5, C=10, D=15, and E=20) known to those having ordinary skill in the art. Note in the tables that the first, say, two times a “Need More Time” action is taken results in a deduction of A points each time, but the next, say, two times this action is taken results in a deduction of B points each time. No more than, say, four “Need More Time” actions may be taken in the examples shown. In addition, a candidate may withdraw from the process at anytime, and this will result in an automatic deduction of, say, B points from the recruiter/referrer who introduced the candidate. In a similar manner, a hirer may reject the candidate at any time, and this will result in an automatic deduction of, say, B points from the recruiter/referrer who introduced the candidate. Finally, points that have no deadlines associated therewith means that the points are awarded or deducted automatically.

### Example 1

### Search Proposal Negotiation Between Recruiter and Hirer

| ACTION | NEXT STEP | POINTS TO | DEADLINES | POINTS |
|---|---|---|---|---|
| Hirer sent Search | Recruiter needs to | Recruiter | Recruiter Takes Action | C |
| Proposal to | Take Action | | within 7 days from | |
| Recruiter | | | receipt | |
| | | | Recruiter Takes Action | −B |
| | | | between 7 and 14 days | |
| | | | from receipt | |
| | | | Recruiter does not Take | −C |
| | | | Action >14 days | |
| | Accept Search | | | |
| | Proposal | | | |
| | Suggest Changes | | | |
| | Reject Search | | | |
| | Proposal | | | |
| | Hirer can take | | | |
| | Optional Action | | | |
| | Withdraw Search | | | |
| | Proposal | | | |
| Search Proposal | Hirer needs to Take | Hirer | Hirer Takes Action within | C |
| sent from Recruiter | Action | | 7 days from receipt | |
| to Hirer | | | | |
| | | | Hirer Takes Action | −B |
| | | | between 7 and 14 days | |
| | | | from receipt | |
| | | | Hirer does not Take | −C |
| | | | Action >14 days | |
| | Accept Search | | | |
| | Proposal | | | |
| | Suggest Changes | | | |
| | Reject Search | | | |
| | Proposal | | | |
| | Need More Time | Hirer | | −A/−B |
| | Recruiter can take | | | |
| | Optional Action | | | |
| | Withdraw Search | | | |
| | Proposal | | | |
| Proposal Withdrawn | No Action | | | |
| by Hirer | | | | |
| Proposal Withdrawn | No Action | | | |
| by Recruiter | | | | |
| Search Proposal | Recruiter needs to | Recruiter | Recruiter Takes Action | C |
| Changed by Hirer | Take Action | | within 7 days from receipt | |
| | | | Recruiter Takes Action | −B |
| | | | between 7 and 14 days | |
| | | | from receipt | |
| | | | Recruiter does not Take | −C |
| | | | Action >14 days | |
| | Accept Search | | | |
| | Proposal | | | |
| | Suggest Changes | | | |
| | Reject Search | | | |
| | Proposal | | | |
| | Hirer can take | | | |
| | Optional Action | | | |
| | Withdraw Search | | | |
| | Proposal | | | |
| Search Proposal | Hirer needs to Take | Hirer | Hirer Takes Action within | C |
| Changed by | Action | | 7 days from receipt | |
| Recruiter | | | | |
| | | | Hirer Takes Action | −B |
| | | | between 7 and 14 days | |
| | | | from receipt | |
| | | | Hirer does not Take | −C |
| | | | Action >14 days | |
| | Accept Search | | | |
| | Proposal | | | |
| | Suggest Changes | | | |
| | Reject Search | | | |
| | Proposal | | | |
| | Need More Time | Hirer | | −A/−B |
| | Recruiter can take | | | |
| | Optional Action | | | |
| | Withdraw Search | | | |
| | Proposal | | | |
| Search Proposal | Recruiter needs to | | | |
| Accepted by | Take Action | | | |
| Recruiter | | | | |
| | Refer Candidates | Recruiter | Introduced 0 Candidates | −C |
| | | | before Delivery Deadline | |
| | | | 1 Candidate | B |
| | | | 2 Candidates | C |
| | | | 3 or more Candidates | D |
| | Hirer can take | | | |
| | Optional Action | | | |
| | Withdraw Search | | | |
| | Proposal | | | |
| Search Proposal | Recruiter needs to | | | |
| Accepted by Hirer | Take Action | | | |
| | Refer Candidates | Recruiter | Introduced 0 Candidates | −C |
| | | | before Delivery Deadline | |
| | | | 1 Candidate | B |
| | | | 2 Candidates | C |
| | | | 3 or more Candidates | D |
| | Hirer can take | | | |
| | Optional Action | | | |
| | Withdraw Search | | | |
| | Proposal | | | |

Process continues at Recruitment Process between Hirer and Recruiter

### Example 2

### Service Charge Negotiation Between Recruiter and Hirer

| ACTION | NEXT STEP | POINTS TO | DEADLINES | POINTS |
|---|---|---|---|---|
| Recruiter sent | Hirer needs to Take | Hirer | Hirer Takes Action within | C |
| Candidate to Hirer | Action | | 7 days from receipt | |
| | | | Hirer Takes Action | −B |
| | | | between 7 and 14 days | |
| | | | from receipt | |
| | | | Hirer does not Take | −C |
| | | | Action >14 days | |
| | Accept Service | | | |
| | Charge | | | |
| | Suggest Changes | | | |
| | Reject Service | | | |
| | Charge | | | |
| | Need More time | | | −A/−B |
| Hirer send request | Recruiter needs to | Recruiter | Recruiter Takes Action | C |
| for Candidates to | Take Action | | within 7 days from receipt | |
| Recruiter | | | | |
| | | | Recruiter Takes Action | −B |
| | | | between 7 and 14 days | |
| | | | from receipt | |
| | | | Recruiter does not Take | −C |
| | | | Action >14 days | |
| | Refer Candidate(s) | Recruiter | | B |
| | Do not have suitable | | | |
| | Candidate(s) | | | |
| | Suggest Search | | | |
| | Proposal | | | |
| | Hirer can take | | | |
| | Optional Action | | | |
| | Withdraw Request | | | |
| | for Candidates | | | |
| Hirer proposed | Recruiter needs to | Recruiter | Recruiter Takes Action | C |
| different Service | Take Action | | within 7 days from receipt | |
| Charge | | | | |
| | | | Recruiter Takes Action | −B |
| | | | between 7 and 14 days | |
| | | | from receipt | |
| | | | Recruiter does not Take | −C |
| | | | Action >14 days | |
| | Accept Service | | | |
| | Charge | | | |
| | Suggest Changes | | | |
| | Reject Service | | | |
| | Charge | | | |
| Recruiter proposed | Hirer needs to Take | Hirer | Hirer Takes Action within | C |
| different Service | Action | | 7 days from receipt | |
| Charge | | | | |
| | | | Hirer Takes Action | −B |
| | | | between 7 and 14 days | |
| | | | from receipt | |
| | | | Hirer does not Take | −C |
| | | | Action >14 days | |
| | Accept Service | | | |
| | Charge | | | |
| | Suggest Changes | | | |
| | Reject Service | | | |
| | Charge | | | |
| | Need More Time | | | −A/−B |
| Service Charge | Hirer needs to Take | Hirer | Hirer Takes Action within | C |
| accepted by | Action | | 7 days from receipt | |
| Recruiter | | | | |
| | | | Hirer Takes Action | −B |
| | | | between 7 and 14 days | |
| | | | from receipt | |
| | | | Hirer does not Take | −C |
| | | | Action >14 days | |
| | Extend a Job Offer | Recruiter | | E |
| | Invite to First | Recruiter | | C |
| | Interview | | | |
| | Reject Candidate | Recruiter | | −B |
| | Need More time | Hirer | | −A/−B |
| Service Charge | Hirer needs to Take | Hirer | Hirer Takes Action within | C |
| accepted by Hirer | Action | | 7 days from receipt | |
| | | | Hirer Takes Action | −B |
| | | | between 7 and 14 days | |
| | | | from receipt | |
| | | | Hirer does not Take | −C |
| | | | Action >14 days | |
| | Extend a Job Offer | Recruiter | | E |
| | Invite to First | Recruiter | | C |
| | Interview | | | |
| | Reject Candidate | Recruiter | | −B |
| | Need More time | Hirer | | −A/−B |

Process continues at Recruitment Process between Hirer and Recruiter

### Example 3

### Service Charge Split Negotiation Between Recruiters

| ACTION | NEXT STEP | POINTS TO | DEADLINES | POINTS |
|---|---|---|---|---|
| Recruiter 1 sent | Recruiter A needs to | Recruiter A | Recruiter Takes Action | C |
| Request Candidates | Take Action | | within 7 days from receipt | |
| to Recruiter A | | | | |
| (Process will start | | | | |
| with this step) | | | | |
| | | | Recruiter Takes Action | −B |
| | | | between 7 and 14 days | |
| | | | from receipt | |
| | | | Recruiter does not Take | −C |
| | | | Action >14 days | |
| | Refer Candidate(s) | Recruiter A | | B |
| | Do not have suitable | | | |
| | Candidate(s) | | | |
| | Recruiter 1 can take | | | |
| | Optional Action | | | |
| | Withdraw Request | | | |
| | for Candidate(s) | | | |
| Recruiter A sent | Recruiter 1 needs to | Recruiter 1 | Recruiter Takes Action | C |
| Candidate(s) to | Take Action | | within 7 days from receipt | |
| Recruiter 1 | | | | |
| | | | Recruiter Takes Action | −B |
| | | | between 7 and 14 days | |
| | | | from receipt | |
| | | | Recruiter does not Take | −C |
| | | | Action >14 days | |
| | Accept Service | | | |
| | Charge Split | | | |
| | Suggest different | | | |
| | Service Charge Split | | | |
| | Reject Service | | | |
| | Charge Split | | | |
| Recruiter 1 propose | Recruiter A needs to | Recruiter A | Recruiter Takes Action | C |
| different Service | Take Action | | within 7 days from receipt | |
| Charge Split | | | | |
| | | | Recruiter Takes Action | −B |
| | | | between 7 and 14 days | |
| | | | from receipt | |
| | | | Recruiter does not Take | −C |
| | | | Action >14 days | |
| | Accept Service | | | |
| | Charge Split | | | |
| | Suggest different | | | |
| | Service Charge Split | | | |
| | Reject Service | | | |
| | Charge Split | | | |
| | Recruiter 1 can take | | | |
| | Optional Action | | | |
| | Withdraw Request | | | |
| | for Candidate(s) | | | |
| Recruiter A propose | Recruiter 1 needs to | Recruiter 1 | Recruiter Takes Action | C |
| different Service | Take Action | | within 7 days from receipt | |
| Charge Split | | | | |
| | | | Recruiter Takes Action | −B |
| | | | between 7 and 14 days | |
| | | | from receipt | |
| | | | Recruiter does not Take | −C |
| | | | Action >14 days | |
| | Accept Service | | | |
| | Charge Split | | | |
| | Suggest different | | | |
| | Service Charge Split | | | |
| | Reject Service | | | |
| | Charge Split | | | |
| Recruiter 1 | Recruiter 1 needs to | Recruiter 1 | Recruiter Takes Action | C |
| accepted Service | Take Action | | within 7 days from receipt | |
| Charge Split | | | | |
| | | | Recruiter Takes Action | −B |
| | | | between 7 and 14 days | |
| | | | from receipt | |
| | | | Recruiter does not Take | −C |
| | | | Action >14 days | |
| | Refer Candidate(s) | Recruiter 1 | | B |
| | Accept Candidate(s) | | | |
| | Reject Candidate(s) | Recruiter A | | −B |
| | Recruiter A can take | | | |
| | Optional Action | | | |
| | Refer Additional | Recruiter A | | B |
| | Candidate(s) | | | |
| Recruiter A | Recruiter 1 needs to | Recruiter 1 | Recruiter Takes Action | C |
| accepted Service | Take Action | | within 7 days from receipt | |
| Charge Split | | | | |
| | | | Recruiter Takes Action | −B |
| | | | between 7 and 14 days | |
| | | | from receipt | |
| | | | Recruiter does not Take | −C |
| | | | Action >14 days | |
| | Refer Candidate | Recruiter 1 | | B |
| | Accept Candidate | | | |
| | Reject Candidate | Recruiter A | | −B |
| | Recruiter A can take | | | |
| | Optional Action | | | |
| | Refer Additional | Recruiter A | | B |
| | Candidate(s) | | | |

### Example 4

### Recruitment Process Between Hirer and Referrer

| ACTION | NEXT STEP | POINTS TO | DEADLINES | POINTS |
|---|---|---|---|---|
| Hirer send request | Referrer needs to | Referrer | Referrer Takes Action | C |
| for Candidates to | Take Action | | within 7 days from receipt | |
| Referrer | | | | |
| | | | Referrer Takes Action | −B |
| | | | between 7 and 14 days | |
| | | | from receipt | |
| | | | Referrer does not Take | −C |
| | | | Action >14 days | |
| | Refer Candidate(s) | Referrer | | B |
| | Do not have suitable | | | |
| | Candidate(s) | | | |
| Referrer sent | Hirer needs to Take | Hirer | Hirer Takes Action within | C |
| Candidate to Hirer | Action | | 7 days from receipt | |
| | | | Hirer Takes Action | −B |
| | | | between 7 and 14 days | |
| | | | from receipt | |
| | | | Hirer does not Take | −C |
| | | | Action >14 days | |
| | Extend a Job Offer | Referrer | | E |
| | Invite to First | Referrer | | C |
| | Interview | | | |
| | Reject Candidate | Referrer | | −B |
| | Need More time | Hirer | | −A/−B |
| Hirer invited | Candidate needs to | | | |
| Candidate to First | Take Action | | | |
| Interview | | | | |
| | Confirm proposed | | | |
| | date and time | | | |
| | Reject and Propose | | | |
| | different date and | | | |
| | time | | | |
| | Withdraw from the | Referrer | | −B |
| | recruitment process | | | |
| | Hirer can take | | | |
| | Optional Action | | | |
| | Reject Candidate | Referrer | | −B |
| First Interview date | Hirer needs to Take | Hirer | Hirer Takes Action within | C |
| passed | Action | | 7 days from receipt | |
| | | | Hirer Takes Action | −B |
| | | | between 7 and 14 days | |
| | | | from receipt | |
| | | | Hirer does not Take | −C |
| | | | Action >14 days | |
| | Invite to a Second | Referrer | | B |
| | Interview | | | |
| | Extend a Job Offer | Referrer | | E |
| | Reject Candidate | Referrer | | −B |
| | Need More time | Hirer | | −A/−B |
| Candidate proposed | Hirer needs to Take | Hirer | Hirer Takes Action within | C |
| different interview | Action | | 7 days from receipt | |
| date and time | | | | |
| | | | Hirer Takes Action | −B |
| | | | between 7 and 14 days | |
| | | | from receipt | |
| | | | Hirer does not Take | −C |
| | | | Action >14 days | |
| | Accept Interview | | | |
| | Date and Time | | | |
| | Suggest different | | | |
| | Interview Date and | | | |
| | Time | | | |
| | Extend a Job Offer | Referrer | | E |
| | Need More Time | Hirer | | −A/−B |
| Hirer invited | Candidate needs to | | | |
| Candidate to | Take Action | | | |
| another interview | | | | |
| | Confirm proposed | | | |
| | date and time | | | |
| | Reject and Propose | | | |
| | different date and | | | |
| | time | | | |
| | Withdraw from the | Referrer | | −B |
| | recruitment process | | | |
| | Hirer can take | | | |
| | Optional Action | | | |
| | Reject Candidate | Referrer | | −B |
| Another Interview | Hirer needs to Take | Hirer | Hirer Takes Action within | C |
| date passed | Action | | 7 days from receipt | |
| | | | Hirer Takes Action | −B |
| | | | between 7 and 14 days | |
| | | | from receipt | |
| | | | Hirer does not Take | −C |
| | | | Action >14 days | |
| | Invite to a Third | Referrer | | B |
| | Interview | | | |
| | Extend a Job Offer | Referrer | | E |
| | Reject Candidate | Referrer | | −B |
| | Need More time | Hirer | | −A/−B |
| Hirer extended Job | Hirer needs to Take | Hirer | Hirer Takes Action within | C |
| Offer | Action | | 7 days from receipt | |
| | | | Hirer Takes Action | −B |
| | | | between 7 and 14 days | |
| | | | from receipt | |
| | | | Hirer does not Take | −C |
| | | | Action >14 days | |
| | Send Provisional | | | |
| | Contract to | | | |
| | Candidate | | | |
| | Reject Candidate | Referrer | | −B |
| | Need More Time | Hirer | | −A/−B |
| Hirer sent | Candidate needs to | | | |
| Provisional Contract | Take Action | | | |
| to Candidate | | | | |
| | Accept the terms set | | | |
| | out in the Provisional | | | |
| | Contract and | | | |
| | commence | | | |
| | employment | | | |
| | Accept Start Date of | | | |
| | Employment and | | | |
| | propose the | | | |
| | following changes to | | | |
| | the terms set out in | | | |
| | the Provisional | | | |
| | Contract | | | |
| | Accept the terms set | | | |
| | out in the Provisional | | | |
| | Contract and | | | |
| | propose different | | | |
| | start date of | | | |
| | employment | | | |
| | Propose the | | | |
| | following changes to | | | |
| | the terms set out in | | | |
| | the Provisional | | | |
| | Contract and | | | |
| | propose different | | | |
| | Start Date of | | | |
| | Employment | | | |
| | Withdraw from the | Referrer | | −B |
| | recruitment process | | | |
| | Hirer can take | | | |
| | Optional Action | | | |
| | Reject Candidate | Referrer | | −B |
| Candidate proposed | Hirer needs to Take | Hirer | Hirer Takes Action within | C |
| changes to the | Action | | 7 days from receipt | |
| provisional contract | | | | |
| | | | Hirer Takes Action | −B |
| | | | between 7 and 14 days | |
| | | | from receipt | |
| | | | Hirer does not Take | −C |
| | | | Action >14 days | |
| | Accept changes to | | | |
| | the Provisional | | | |
| | Contract | | | |
| | Suggest changes to | | | |
| | the Provisional | | | |
| | Contract | | | |
| | Reject Candidate | Referrer | | −B |
| | Need More Time | Hirer | | −A/−B |
| Hirer accepted | Hirer needs to Take | Hirer | Hirer Takes Action within | C |
| changes to the | Action | | 7 days from receipt | |
| provisional contract | | | | |
| and starting date | | | | |
| | | | Hirer Takes Action | −B |
| | | | between 7 and 14 days | |
| | | | from receipt | |
| | | | Hirer does not Take | −C |
| | | | Action >14 days | |
| | Formal Contract | | | |
| | Delivery Details | | | |
| | Reject Candidate | Referrer | | −B |
| | Need More Time | Hirer | | −A/−B |
| Candidate accepted | Hirer needs to Take | Hirer | Hirer Takes Action within | C |
| terms of provisional | Action | | 7 days from receipt | |
| contract and | | | | |
| starting date | | | | |
| | | | Hirer Takes Action | −B |
| | | | between 7 and 14 days | |
| | | | from receipt | |
| | | | Hirer does not Take | −C |
| | | | Action >14 days | |
| | Formal Contract | | | |
| | Delivery Details | | | |
| | Reject Candidate | Referrer | | −B |
| | Need More Time | Hirer | | −A/−B |
| Hirer sent Formal | Candidate needs to | | | |
| Contract to | Take Action | | | |
| Candidate for | | | | |
| completion | | | | |
| | Received Formal | | | |
| | Contract | | | |
| | Did Not Receive | | | |
| | Formal Contract | | | |
| | Withdraw from the | Referrer | | −B |
| | recruitment process | | | |
| | Hirer can take | | | |
| | Optional Action | | | |
| | Reject Candidate | Referrer | | −B |
| Candidate received | Candidate needs to | | | |
| Formal Contract | Take Action | | | |
| | Formal Contract | | | |
| | Delivery Details | | | |
| | Withdraw from the | Referrer | | −B |
| | recruitment process | | | |
| | Hirer can take | | | |
| | Optional Action | | | |
| | Reject Candidate | Referrer | | −B |
| | Did Not Receive | | Hirer does not Take | −C |
| | Executed Formal | | Action >14 days from | |
| | Contract | | Job Start Date | |
| Candidate | Hirer needs to Take | Hirer | Hirer Takes Action within | C |
| commenced | Action | | 7 days from receipt | |
| employment on the | | | | |
| scheduled date | | | | |
| | | | Hirer Takes Action | −B |
| | | | between 7 and 14 days | |
| | | | from receipt | |
| | | | Hirer does not Take | −C |
| | | | Action >14 days | |
| | Candidate | Referrer | | E |
| | Commenced | | | |
| | Employment on the | | | |
| | Scheduled Date | | | |
| | Candidate Did Not | Referrer | | −C |
| | Commence | | | |
| | Employment on the | | | |
| | Scheduled Date | | | |
| | Propose New Start | | | |
| | Date | | | |
| | Reject Candidate | Referrer | | −B |
| | Need More Time | Hirer | | −A/−B |
| Hirer confirmed | Referrer needs to | Referrer | Referrer Takes Action | C |
| receipt of completed | Take Action | | within 7 days from receipt | |
| Formal Contract | | | | |
| from Candidate | | | | |
| | Claim Reward | | Referrer Takes Action | −B |
| | | | between 7 and 14 days | |
| | | | from receipt | |
| | Request More Info | | Referrer does not Take | −C |
| | | | Action >14 days | |
| Referrer claimed | Hirer needs to Take | Hirer | Hirer Takes Action within | C |
| reward from Hirer | Action | | 7 days from receipt | |
| | Payment Delivery | | Hirer Takes Action | −B |
| | Details | | between 7 and 14 days | |
| | | | from receipt | |
| | Request More Info | | Hirer does not Take | −C |
| | | | Action >14 days | |
| After 3 Months | Hirer needs to Take | Hirer | Hirer Takes Action within | C |
| | Action | | 7 days from receipt | |
| | | | Hirer Takes Action | −B |
| | | | between 7 and 14 days | |
| | | | from receipt | |
| | | | Hirer does not Take | −C |
| | | | Action >14 days | |
| | Candidate left in less | Referrer | | −C |
| | than 3 months | | | |
| | Candidate still | Referrer | | E |
| | employed after 3 | | | |
| | months | | | |
| | Need More Time | Hirer | | −A/−B |

### Example 5

### Recruitment Process Between Hirer and Recruiter

| ACTION | NEXT STEP | POINTS TO | DEADLINES | POINTS |
|---|---|---|---|---|
| Hirer invited | Candidate needs to | | | |
| Candidate to First | Take Action | | | |
| Interview | | | | |
| | Confirm proposed | | | |
| | date and time | | | |
| | Reject and Propose | | | |
| | different date and | | | |
| | time | | | |
| | Withdraw from the | Recruiter | | −B |
| | recruitment process | | | |
| | Hirer can take | | | |
| | Optional Action | | | |
| | Reject Candidate | Recruiter | | −B |
| First Interview date | Hirer needs to Take | Hirer | Hirer Takes Action within | C |
| passed | Action | | 7 days from receipt | |
| | | | Hirer Takes Action | −B |
| | | | between 7 and 14 days | |
| | | | from receipt | |
| | | | Hirer does not Take | −C |
| | | | Action >14 days | |
| | Invite to a Second | Recruiter | | B |
| | Interview | | | |
| | Extend a Job Offer | Recruiter | | E |
| | Reject Candidate | Recruiter | | −B |
| | Need More time | Hirer | | −A/−B |
| Candidate proposed | Hirer needs to Take | Hirer | Hirer Takes Action within | C |
| different interview | Action | | 7 days from receipt | |
| date and time | | | | |
| | | | Hirer Takes Action | −B |
| | | | between 7 and 14 days | |
| | | | from receipt | |
| | | | Hirer does not Take | −C |
| | | | Action >14 days | |
| | Accept Interview | | | |
| | Date and Time | | | |
| | Suggest different | | | |
| | Interview Date and | | | |
| | Time | | | |
| | Extend a Job Offer | Recruiter | | E |
| | Need More Time | Hirer | | −A/−B |
| Hirer invited | Candidate needs to | | | |
| Candidate to | Take Action | | | |
| another interview | | | | |
| | Confirm proposed | | | |
| | date and time | | | |
| | Reject and Propose | | | |
| | different date and | | | |
| | time | | | |
| | Withdraw from the | Recruiter | | −B |
| | recruitment process | | | |
| | Hirer can take | | | |
| | Optional Action | | | |
| | Reject Candidate | Recruiter | | −B |
| Another Interview | Hirer needs to Take | Hirer | Hirer Takes Action within | C |
| date passed | Action | | 7 days from receipt | |
| | Invite to a Third | | Hirer Takes Action | −B |
| | Interview | | between 7 and 14 days | |
| | | | from receipt | |
| | Extend a Job Offer | | Hirer does not Take | −C |
| | | | Action >14 days | |
| | Reject Candidate | Recruiter | | −B |
| | Need More time | Hirer | | −A/−B |
| Hirer extended Job | Hirer needs to Take | Hirer | Hirer Takes Action within | C |
| Offer | Action | | 7 days from receipt | |
| | Send Provisional | | Hirer Takes Action | −B |
| | Contract to | | between 7 and 14 days | |
| | Candidate | | from receipt | |
| | | | Hirer does not Take | −C |
| | | | Action >14 days | |
| | Reject Candidate | Recruiter | | −B |
| | Need More Time | Hirer | | −A/−B |
| Hirer sent | Candidate needs to | | | |
| Provisional Contract | Take Action | | | |
| to Candidate | | | | |
| | Accept the terms set | | | |
| | out in the Provisional | | | |
| | Contract and | | | |
| | commence | | | |
| | employment | | | |
| | Accept Start Date of | | | |
| | Employment and | | | |
| | propose the | | | |
| | following changes to | | | |
| | the terms set out in | | | |
| | the Provisional | | | |
| | Contract | | | |
| | Accept the terms set | | | |
| | out in the Provisional | | | |
| | Contract and | | | |
| | propose different | | | |
| | start date of | | | |
| | employment | | | |
| | Propose the | | | |
| | following changes to | | | |
| | the terms set out in | | | |
| | the Provisional | | | |
| | Contract and | | | |
| | propose different | | | |
| | Start Date of | | | |
| | Employment | | | |
| | Withdraw from the | Recruiter | | −B |
| | recruitment process | | | |
| | Hirer can take | | | |
| | Optional Action | | | |
| | Reject Candidate | Recruiter | | −B |
| Hirer accepted | Hirer needs to Take | Hirer | Hirer Takes Action within | C |
| changes to the | Action | | 7 days from receipt | |
| provisional contract | | | | |
| and starting date | | | | |
| | | | Hirer Takes Action | −B |
| | | | between 7 and 14 days | |
| | | | from receipt | |
| | | | Hirer does not Take | −C |
| | | | Action >14 days | |
| | Formal Contract | | | |
| | Delivery Details | | | |
| | Reject Candidate | Recruiter | | −B |
| | Need More Time | Hirer | | −A/−B |
| Candidate accepted | Hirer needs to Take | Hirer | Hirer Takes Action within | C |
| terms of provisional | Action | | 7 days from receipt | |
| contract and | | | | |
| starting date | | | | |
| | | | Hirer Takes Action | −B |
| | | | between 7 and 14 days | |
| | | | from receipt | |
| | | | Hirer does not Take | −C |
| | | | Action >14 days | |
| | Formal Contract | | | |
| | Delivery Details | | | |
| | Reject Candidate | Recruiter | | −B |
| | Need More Time | Hirer | | −A/−B |
| Hirer sent Formal | Candidate needs to | | | |
| Contract for | Take Action | | | |
| completion to | | | | |
| Candidate and copy | | | | |
| of the Formal | | | | |
| Contract to | | | | |
| Recruiter | | | | |
| | Received Formal | | | |
| | Contract | | | |
| | Did Not Receive | | | |
| | Formal Contract | | | |
| | Withdraw from the | Recruiter | | −B |
| | recruitment process | | | |
| | Hirer can take | | | |
| | Optional Action | | | |
| | Reject Candidate | Recruiter | | −B |
| Candidate received | Candidate needs to | | | |
| Formal Contract | Take Action | | | |
| | Formal Contract | | | |
| | Delivery Details | | | |
| | Withdraw from the | Recruiter | | −B |
| | recruitment process | | | |
| | Hirer can take | | | |
| | Optional Action | | | |
| | Reject Candidate | Recruiter | | −B |
| Candidate | Hirer needs to Take | Hirer | Hirer Takes Action within | C |
| commenced | Action | | 7 days from receipt | |
| employment on the | | | | |
| scheduled date | | | | |
| | | | Hirer Takes Action | −B |
| | | | between 7 and 14 days | |
| | | | from receipt | |
| | | | Hirer does not Take | −C |
| | | | Action >14 days | |
| | Candidate | Recruiter | | E |
| | Commenced | | | |
| | Employment on the | | | |
| | Scheduled Date | | | |
| | Candidate Did Not | Recruiter | | −C |
| | Commence | | | |
| | Employment on the | | | |
| | Scheduled Date | | | |
| | Propose New Start | | | |
| | Date | | | |
| | Reject Candidate | Recruiter | | −B |
| | Need More Time | Hirer | | −A/−B |
| Hirer confirmed | Recruiter needs to | Recruiter | Recruiter Takes Action | C |
| receipt of completed | Take Action | | within 7 days from receipt | |
| Formal Contract | | | | |
| from Candidate | | | | |
| | Claim Reward | | Recruiter Takes Action | −B |
| | | | between 7 and 14 days | |
| | | | from receipt | |
| | Request More Info | | Recruiter does not Take | −C |
| | | | Action >14 days | |
| Recruiter claimed | Hirer needs to Take | Hirer | Hirer Takes Action within | C |
| reward from Hirer | Action | | 7 days from receipt | |
| | Payment Delivery | | Hirer Takes Action | −B |
| | Details | | between 7 and 14 days | |
| | | | from receipt | |
| | Request More Info | | Hirer does not Take | −C |
| | | | Action >14 days | |
| After 3 Months | Hirer needs to Take | Hirer | Hirer Takes Action within | C |
| | Action | | 7 days from receipt | |
| | | | Hirer Takes Action | −B |
| | | | between 7 and 14 days | |
| | | | from receipt | |
| | | | Hirer does not Take | −C |
| | | | Action >14 days | |
| | Candidate left in less | Recruiter | | −C |
| | than 3 months | | | |
| | Candidate still | Recruiter | | E |
| | employed after 3 | | | |
| | months | | | |
| | Need More Time | Hirer | | −A/−B |
| If by Job Closing | | Recruiter | 0 Candidates | −C |
| Date Hirer has | | | | |
| invited to an | | | | |
| Interview or | | | | |
| Extended Job Offer | | | | |
| for candidates that | | | | |
| were introduced | | | | |
| during Search | | | | |
| Assignment then | | | | |
| the points are | | | | |
| adjusted | | | | |
| accordingly | | | | |
| | | | 1 Candidate | B |
| | | | 2 Candidates | C |
| | | | 3 or more Candidates | D |

### Example 6

### Recruiter Requesting Candidate(s) from Referrer

| ACTION | NEXT STEP | POINTS TO | DEADLINES | POINTS |
|---|---|---|---|---|
| Recruiter sent | Referrer needs to | Referrer | Referrer Takes Action | C |
| Request Candidates | Take Action | | within 7 days from receipt | |
| to Referrer | | | | |
| | | | Referrer Takes Action | −B |
| | | | between 7 and 14 days | |
| | | | from receipt | |
| | | | Referrer does not Take | −C |
| | | | Action >14 days | |
| | Refer Candidate(s) | Referrer | | B |
| | Do not have suitable | | | |
| | Candidate(s) | | | |
| Referrer sent | Recruiter needs to | Recruiter | Recruiter Takes Action | C |
| Candidate(s) to | Take Action | | within 7 days from receipt | |
| Recruiter | | | | |
| | | | Recruiter Takes Action | −B |
| | | | between 7 and 14 days | |
| | | | from receipt | |
| | | | Recruiter does not Take | −C |
| | | | Action >14 days | |
| | Refer Candidate(s) | Recruiter | | B |
| | Reject Candidate(s) | Referrer | | −B |
| | Referrer can take | | | |
| | Optional Action | | | |
| | Refer Additional | Referrer | | B |
| | Candidate(s) | | | |

### Example 7

### Hirer Interacting Directly with Candidate(s)

| ACTION | NEXT STEP | POINTS TO | DEADLINES | POINTS |
|---|---|---|---|---|
| Candidate directly | Hirer needs to Take | Hirer | Hirer Takes Action within | C |
| applied for a job | Action | | 14 days from receipt | |
| and send CV to | | | | |
| Hirer | | | | |
| | | | Hirer Takes Action | −B |
| | | | between 14 and 21 days | |
| | | | from receipt | |
| | | | Hirer does not Take | −C |
| | | | Action >21 days | |
| | Extend a Job Offer | | | |
| | Invite to First | | | |
| | Interview | | | |
| | Reject Candidate | | | |
| | Need More time | Hirer | | −A/−B |
| Hirer invited | Candidate needs to | | | |
| Candidate to First | Take Action | | | |
| Interview | | | | |
| | Confirm proposed | | | |
| | date and time | | | |
| | Reject and Propose | | | |
| | different date and | | | |
| | time | | | |
| | Withdraw from the | | | |
| | recruitment process | | | |
| | Hirer can take | | | |
| | Optional Action | | | |
| | Reject Candidate | | | |
| First Interview date | Hirer needs to Take | Hirer | Hirer Takes Action within | C |
| passed | Action | | 7 days from receipt | |
| | | | Hirer Takes Action | −B |
| | | | between 7 and 14 days | |
| | | | from receipt | |
| | | | Hirer does not Take | −C |
| | | | Action >14 days | |
| | Invite to a Second | | | |
| | Interview | | | |
| | Extend a Job Offer | | | |
| | Reject Candidate | | | |
| | Need More time | Hirer | | −A/−B |
| Candidate proposed | Hirer needs to Take | Hirer | Hirer Takes Action within | C |
| different interview | Action | | 7 days from receipt | |
| date and time | | | | |
| | | | Hirer Takes Action | −B |
| | | | between 7 and 14 days | |
| | | | from receipt | |
| | | | Hirer does not Take | −C |
| | | | Action >14 days | |
| | Accept Interview | | | |
| | Date and Time | | | |
| | Suggest different | | | |
| | Interview Date and | | | |
| | Time | | | |
| | Extend a Job Offer | | | |
| | Need More Time | Hirer | | −A/−B |
| Hirer invited | Candidate needs to | | | |
| Candidate to | Take Action | | | |
| another interview | | | | |
| | Confirm proposed | | | |
| | date and time | | | |
| | Reject and Propose | | | |
| | different date and | | | |
| | time | | | |
| | Withdraw from the | | | |
| | recruitment process | | | |
| | Hirer can take | | | |
| | Optional Action | | | |
| | Reject Candidate | | | |
| Another Interview | Hirer needs to Take | Hirer | Hirer Takes Action within | C |
| date passed | Action | | 7 days from receipt | |
| | | | Hirer Takes Action | −B |
| | | | between 7 and 14 days | |
| | | | from receipt | |
| | | | Hirer does not Take | −C |
| | | | Action >14 days | |
| | Invite to a Third | | | |
| | Interview | | | |
| | Extend a Job Offer | | | |
| | Reject Candidate | | | |
| | Need More time | Hirer | | −A/−B |
| Hirer extended Job | Hirer needs to Take | Hirer | Hirer Takes Action within | C |
| Offer | Action | | 7 days from receipt | |
| | | | Hirer Takes Action | −B |
| | | | between 7 and 14 days | |
| | | | from receipt | |
| | | | Hirer does not Take | −C |
| | | | Action >14 days | |
| | Send Provisional | | | |
| | Contract to | | | |
| | Candidate | | | |
| | Reject Candidate | | | |
| | Need More Time | Hirer | | −A/−B |
| Hirer sent | Candidate needs to | | | |
| Provisional | Take Action | | | |
| Contract to | | | | |
| Candidate | | | | |
| | Accept the terms set | | | |
| | out in the | | | |
| | Provisional Contract | | | |
| | and commence | | | |
| | employment | | | |
| | Accept Start Date of | | | |
| | Employment and | | | |
| | propose the | | | |
| | following changes to | | | |
| | the terms set out in | | | |
| | the Provisional | | | |
| | Contract | | | |
| | Accept the terms set | | | |
| | out in the | | | |
| | Provisional Contract | | | |
| | and propose | | | |
| | different start date of | | | |
| | employment | | | |
| | Propose the | | | |
| | following changes to | | | |
| | the terms set out in | | | |
| | the Provisional | | | |
| | Contract and | | | |
| | propose different | | | |
| | Start Date of | | | |
| | Employment | | | |
| | Withdraw from the | | | |
| | recruitment process | | | |
| | Hirer can take | | | |
| | Optional Action | | | |
| | Reject Candidate | | | |
| Candidate proposed | Hirer needs to Take | Hirer | Hirer Takes Action within | C |
| changes to the | Action | | 7 days from receipt | |
| provisional contract | | | | |
| | | | Hirer Takes Action | −B |
| | | | between 7 and 14 days | |
| | | | from receipt | |
| | | | Hirer does not Take | −C |
| | | | Action >14 days | |
| | Accept changes to | | | |
| | the Provisional | | | |
| | Contract | | | |
| | Suggest changes to | | | |
| | the Provisional | | | |
| | Contract | | | |
| | Reject Candidate | | | |
| | Need More Time | Hirer | | −A/−B |
| Hirer accepted | Hirer needs to Take | Hirer | Hirer Takes Action within | C |
| changes to the | Action | | 7 days from receipt | |
| provisional contract | | | | |
| and starting date | | | | |
| | | | Hirer Takes Action | −B |
| | | | between 7 and 14 days | |
| | | | from receipt | |
| | | | Hirer does not Take | −C |
| | | | Action >14 days | |
| | Formal Contract | | | |
| | Delivery Details | | | |
| | Reject Candidate | | | |
| | Need More Time | Hirer | | −A/−B |
| Candidate accepted | Hirer needs to Take | Hirer | Hirer Takes Action within | C |
| terms of provisional | Action | | 7 days from receipt | |
| contract and | | | | |
| starting date | | | | |
| | | | Hirer Takes Action | −B |
| | | | between 7 and 14 days | |
| | | | from receipt | |
| | | | Hirer does not Take | −C |
| | | | Action >14 days | |
| | Formal Contract | | | |
| | Delivery Details | | | |
| | Reject Candidate | | | |
| | Need More Time | Hirer | | −A/−B |
| Hirer sent Formal | Candidate needs to | | | |
| Contract to | Take Action | | | |
| Candidate for | | | | |
| completion | | | | |
| | Received Formal | | | |
| | Contract | | | |
| | Did Not Receive | | | |
| | Formal Contract | | | |
| | Withdraw from the | | | |
| | recruitment process | | | |
| | Hirer can take | | | |
| | Optional Action | | | |
| | Reject Candidate | | | |
| Candidate received | Candidate needs to | | | |
| Formal Contract | Take Action | | | |
| | Formal Contract | | | |
| | Delivery Details | | | |
| | Withdraw from the | | | |
| | recruitment process | | | |
| | Hirer can take | | | |
| | Optional Action | | | |
| | Reject Candidate | | | |
| | Did Not Receive | | Hirer does not Take | −C |
| | Executed Formal | | Action >14 days from | |
| | Contract | | Job Start Date | |
| Candidate | Hirer needs to Take | Hirer | Hirer Takes Action within | C |
| commenced | Action | | 7 days from receipt | |
| employment on the | | | | |
| scheduled date | | | | |
| | | | Hirer Takes Action | −B |
| | | | between 7 and 14 days | |
| | | | from receipt | |
| | | | Hirer does not Take | −C |
| | | | Action >14 days | |
| | Candidate | | | |
| | Commenced | | | |
| | Employment on the | | | |
| | Scheduled Date | | | |
| | Candidate Did Not | | | |
| | Commence | | | |
| | Employment on the | | | |
| | Scheduled Date | | | |
| | Propose New Start | | | |
| | Date | | | |
| | Reject Candidate | | | |
| | Need More Time | Hirer | | −A/−B |
| After 3 Months | Hirer needs to Take | Hirer | Hirer Takes Action within | C |
| | Action | | 7 days from receipt | |
| | | | Hirer Takes Action | −B |
| | | | between 7 and 14 days | |
| | | | from receipt | |
| | | | Hirer does not Take | −C |
| | | | Action >14 days | |
| | Candidate left in | | | |
| | less than 3 months | | | |
| | Candidate still | | | |
| | employed after 3 | | | |
| | months | | | |
| | Need More Time | Hirer | | −A/−B |

Note in Example 7 that a hirer may engage directly with candidates so that there is no interaction between the hirer and a recruiter or referrer. This arrangement allows hirers to search for candidates using their company's own internal job postings or postings on public job boards, such as www.monster.com, www.careerbuilder.com, and the like, but be able to manage the recruitment process through the Web-based recruitment management tool 316. However, the hirer's performance with respect to the candidates will still be reflected in their total FPI and FPI Main Indicators as before, thus motivating hirers to continue performing at a high level and assuring candidates that their submissions will be treated with promptness and responsiveness. As with previous examples, a candidate's performance is not scored and a hirer's score is not affected by a lack of responsiveness from candidates.

Web-Based User Interface

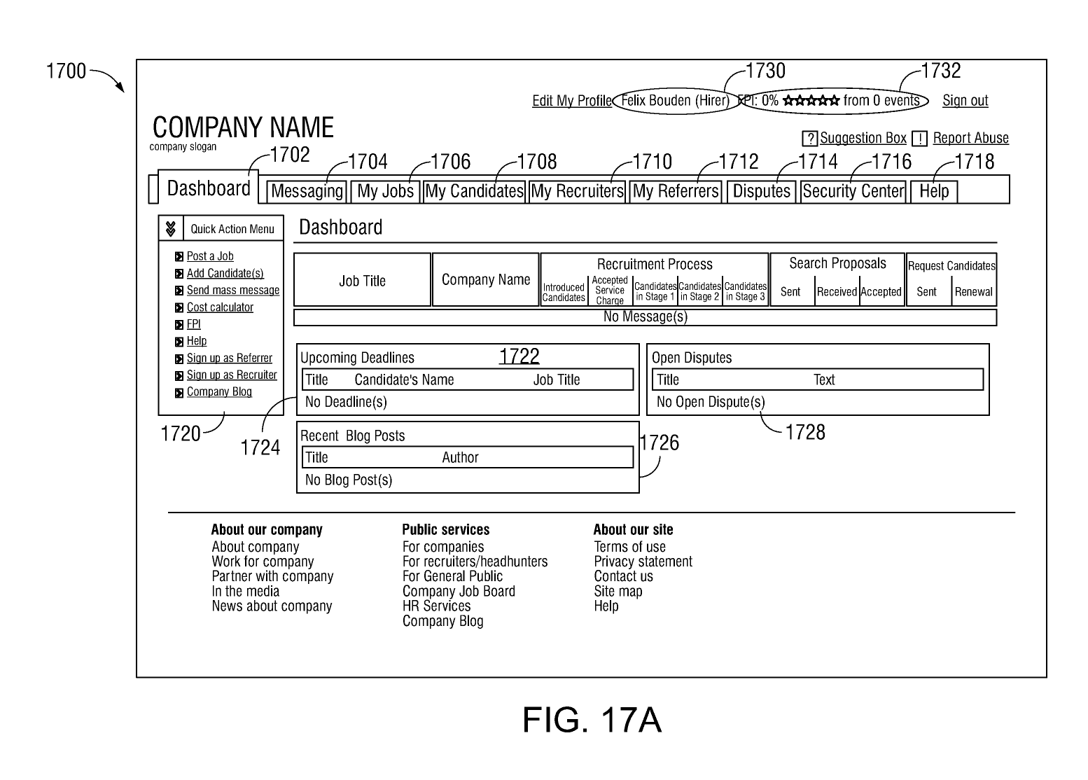

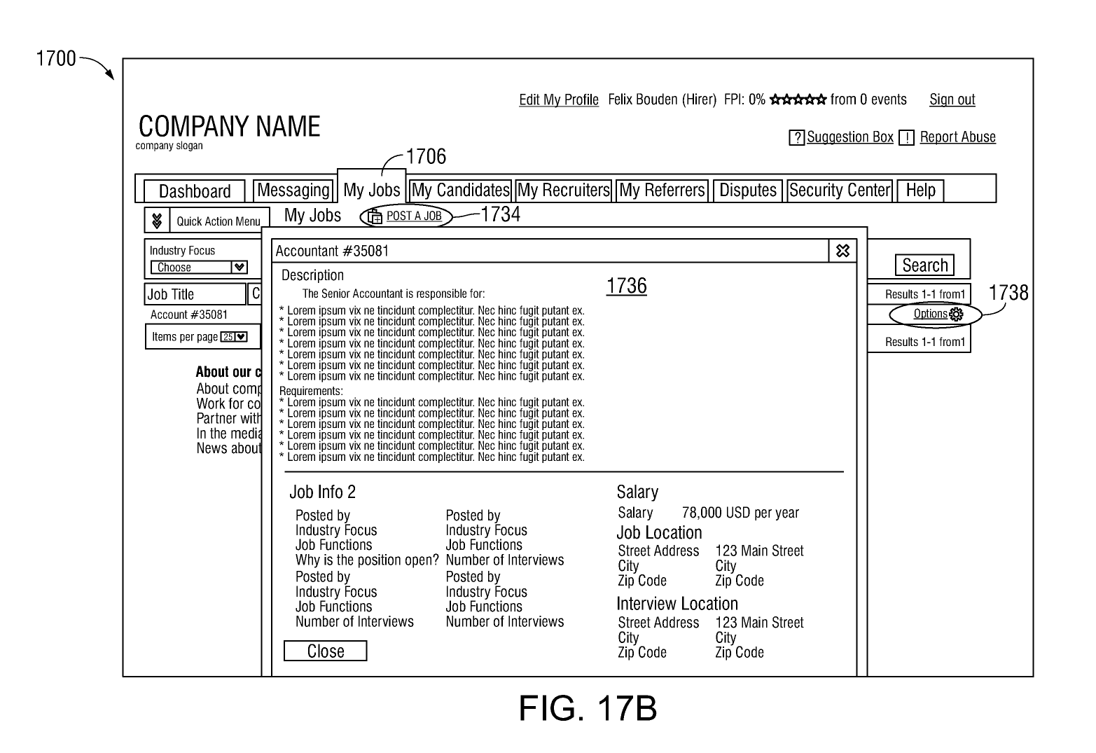

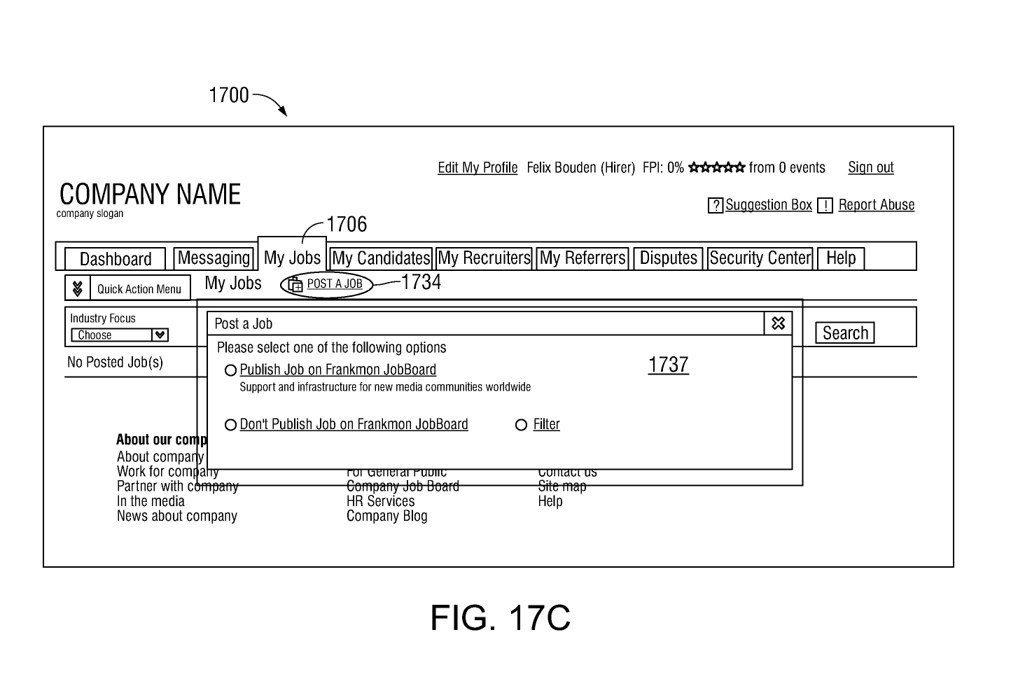

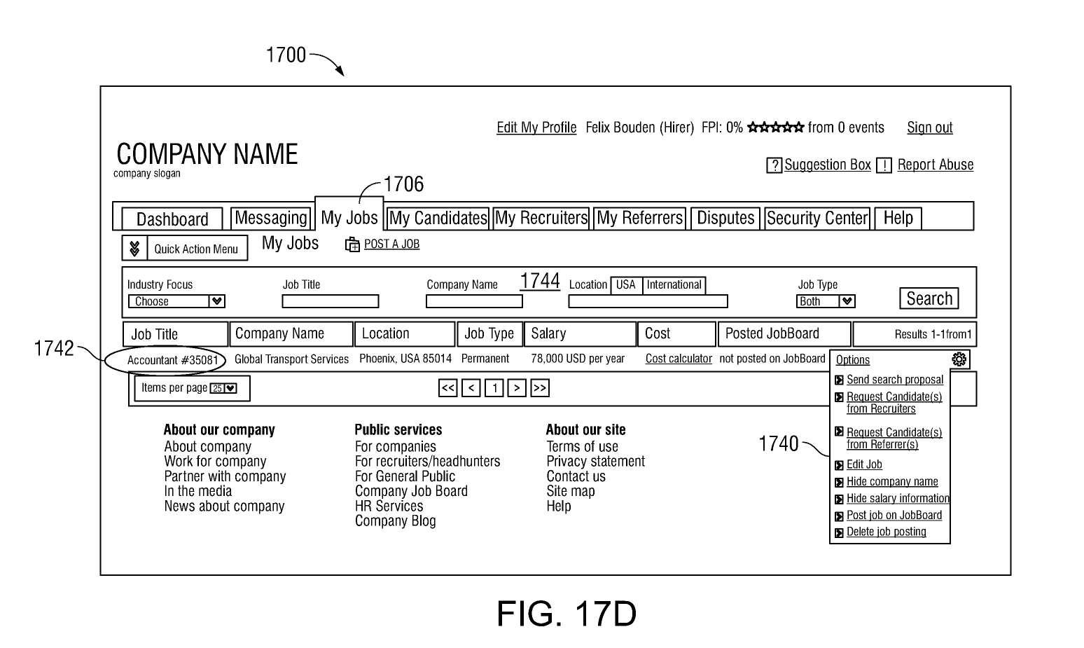

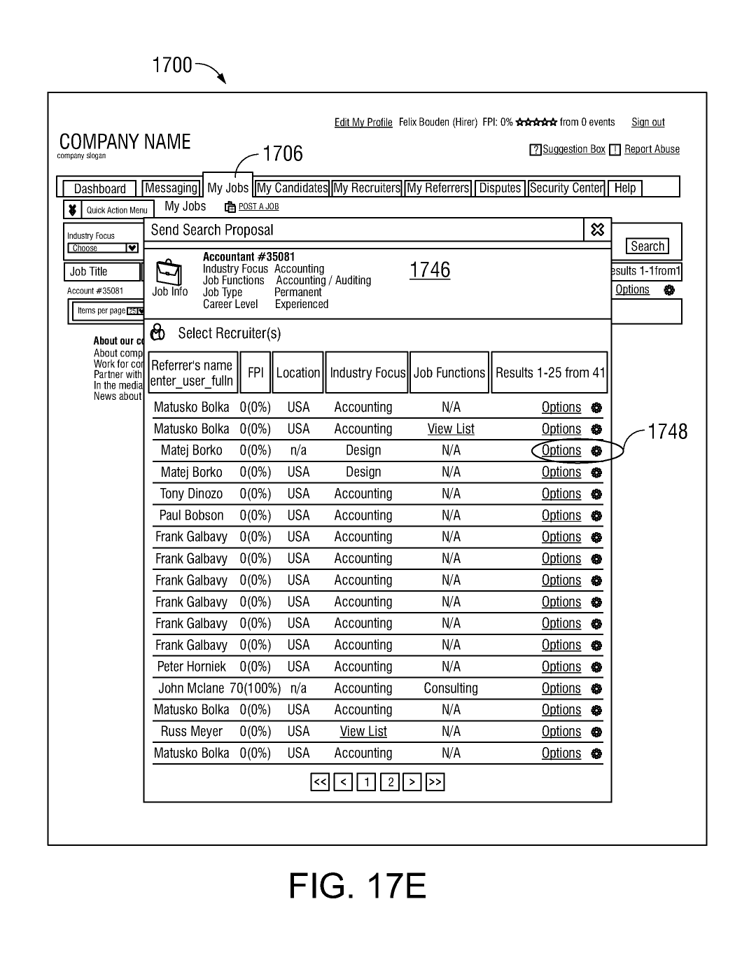

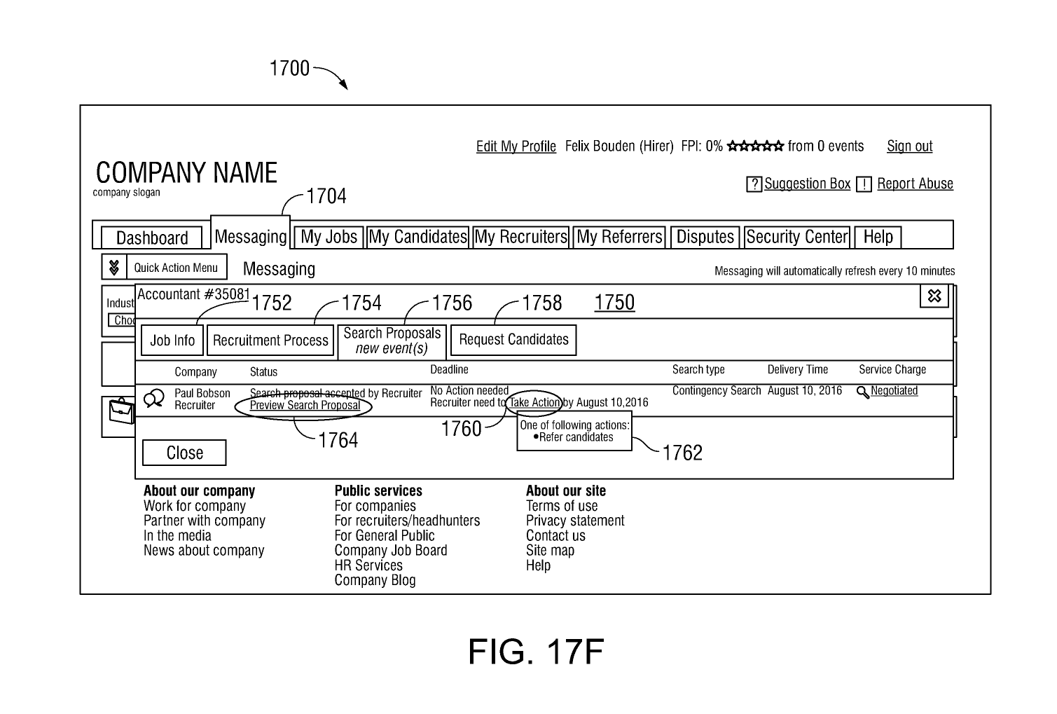

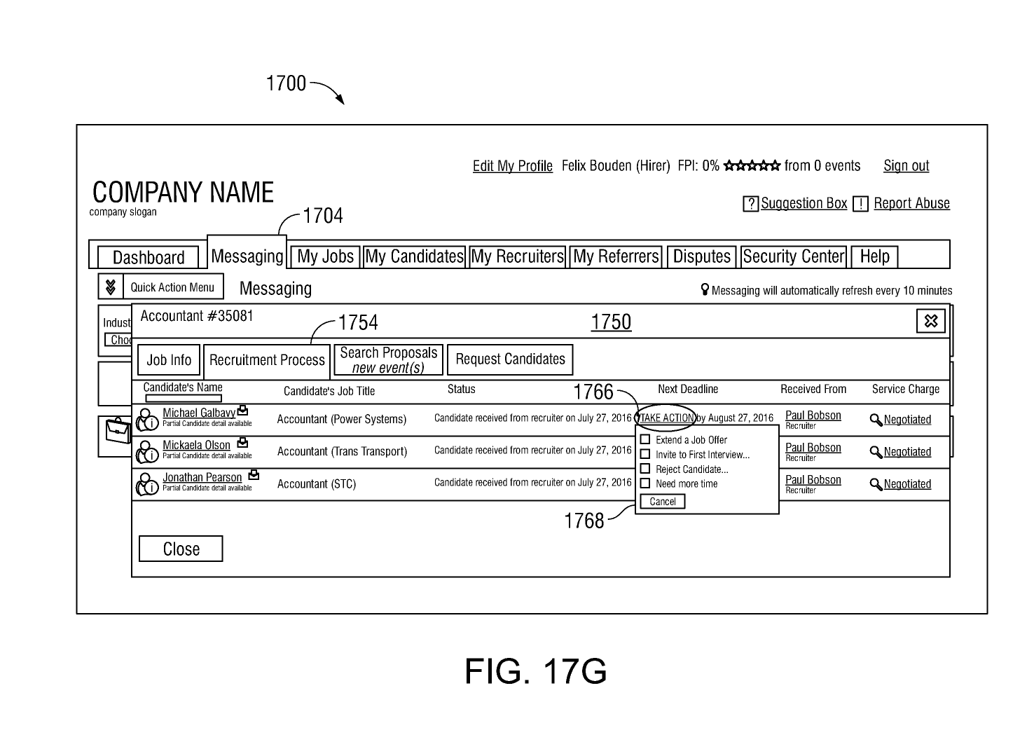

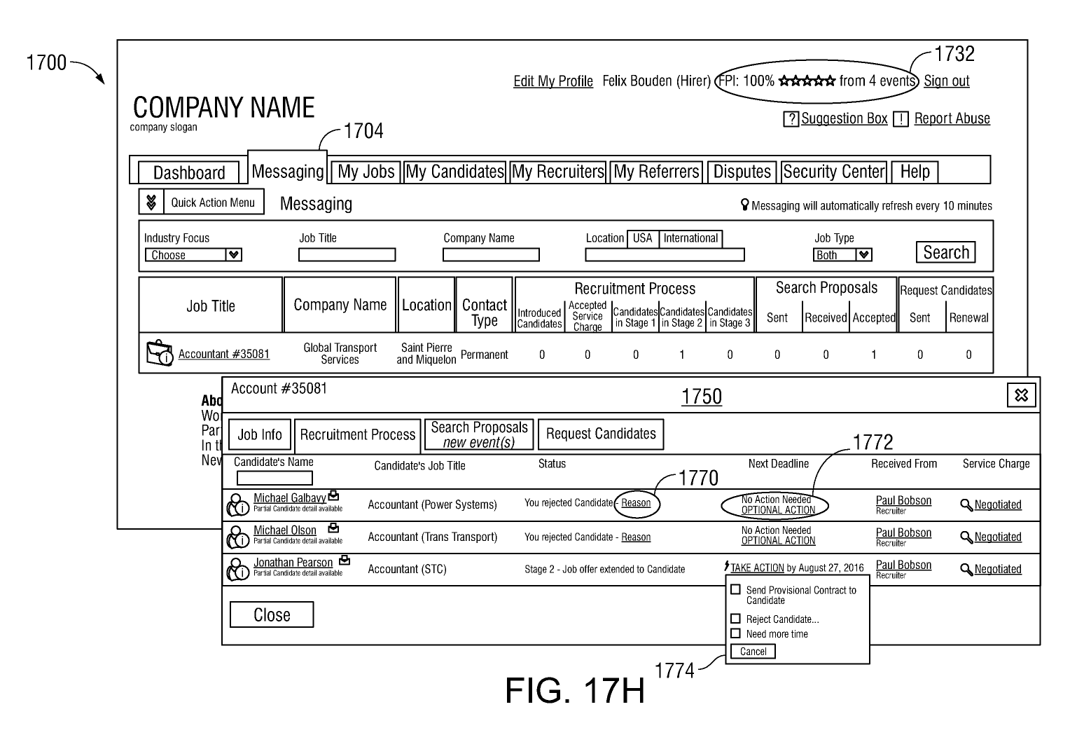

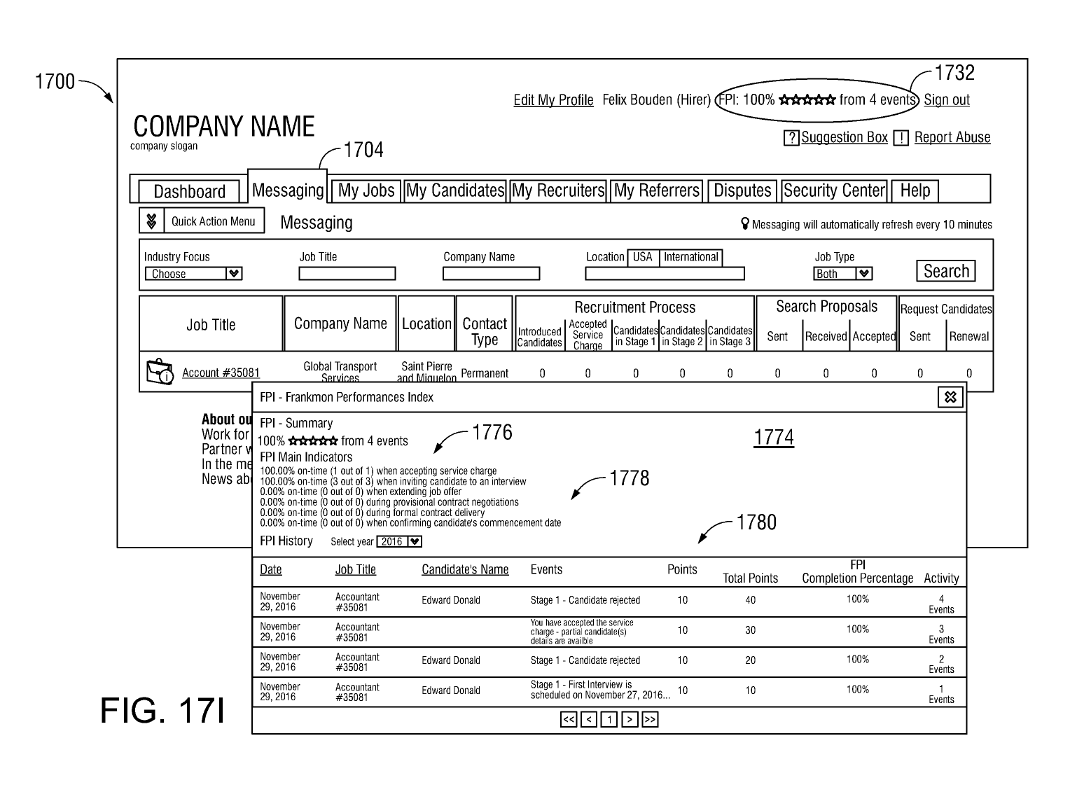

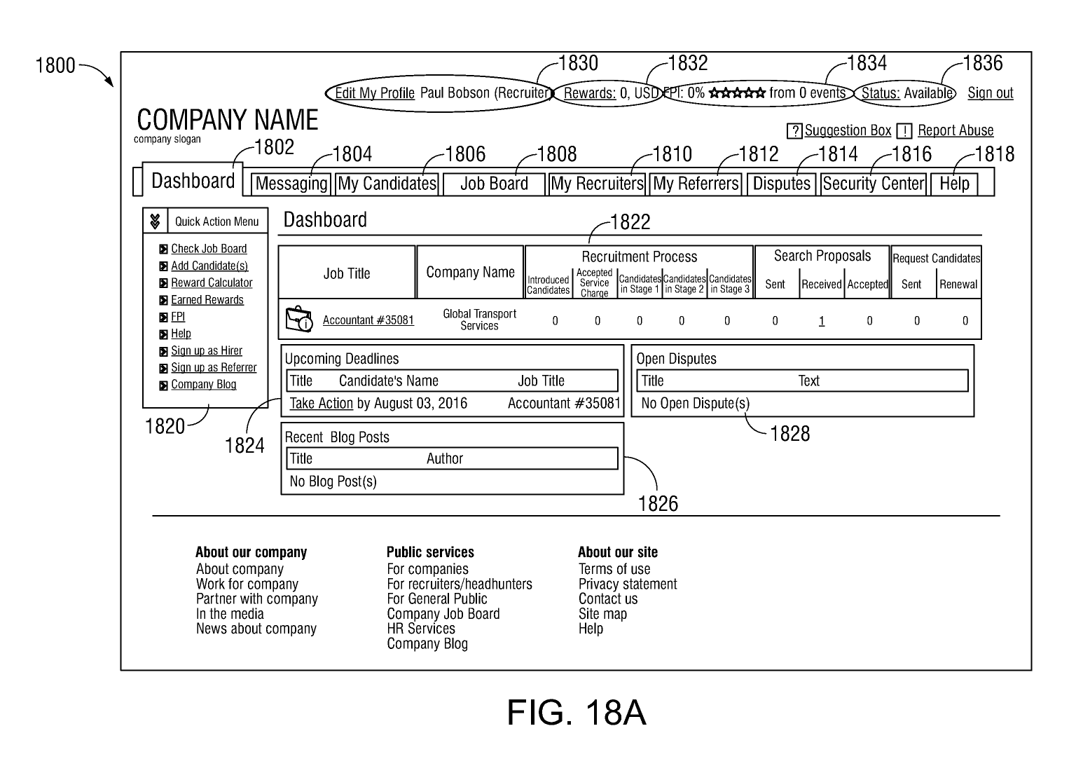

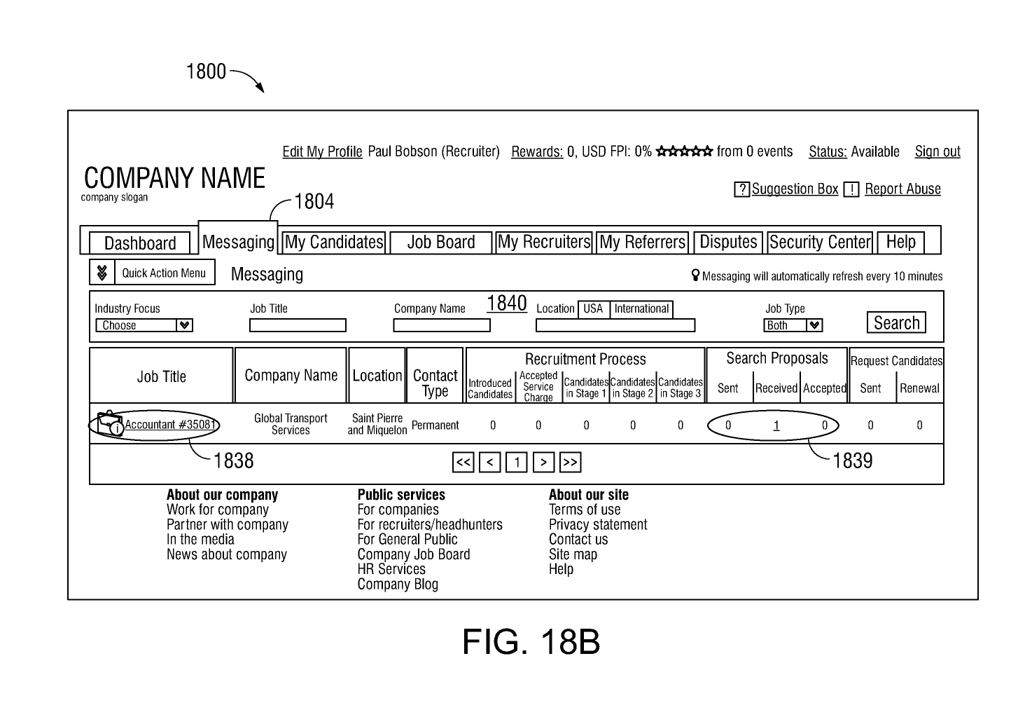

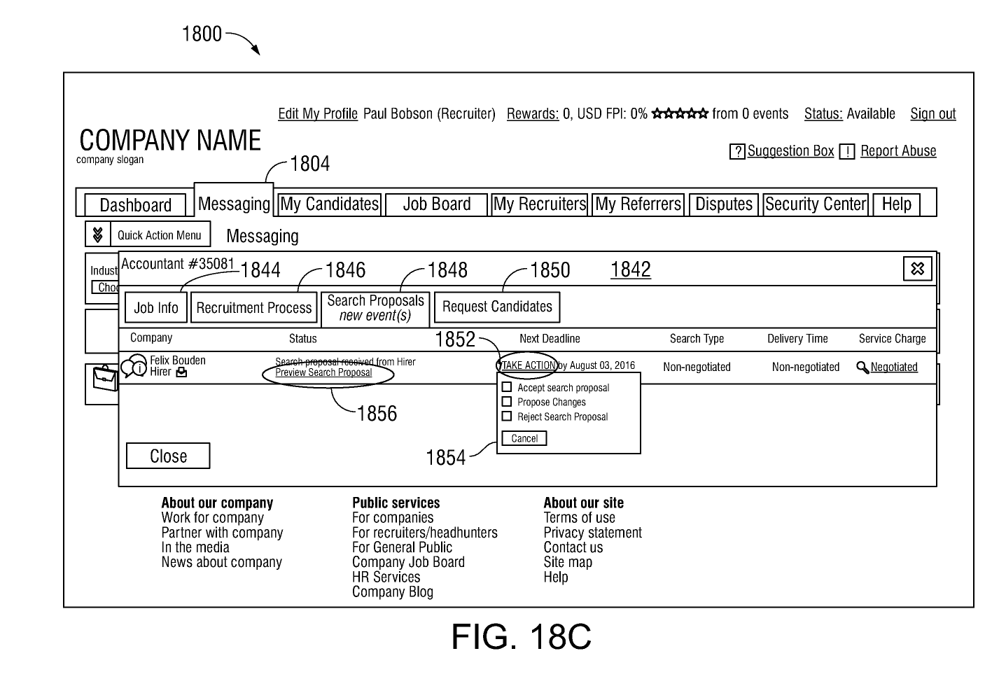

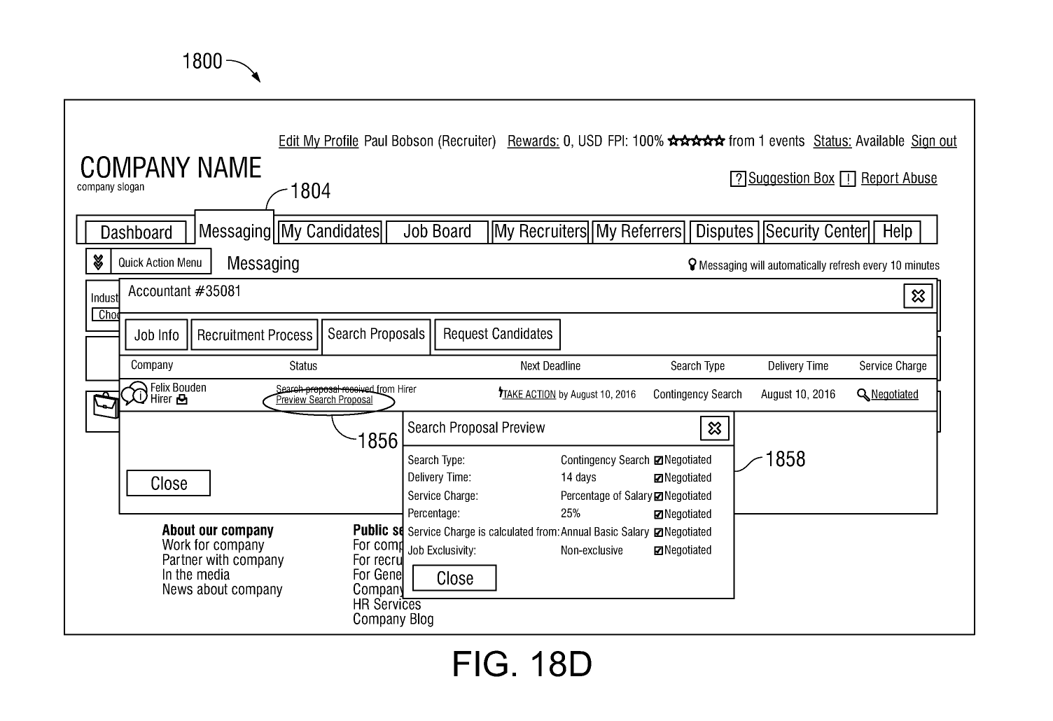

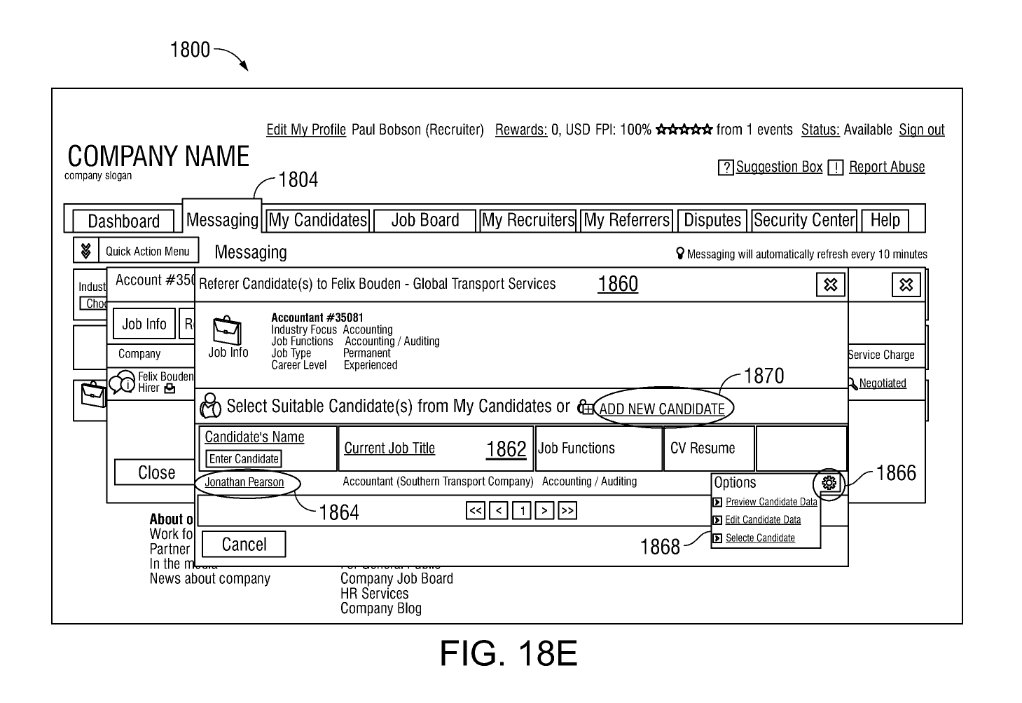

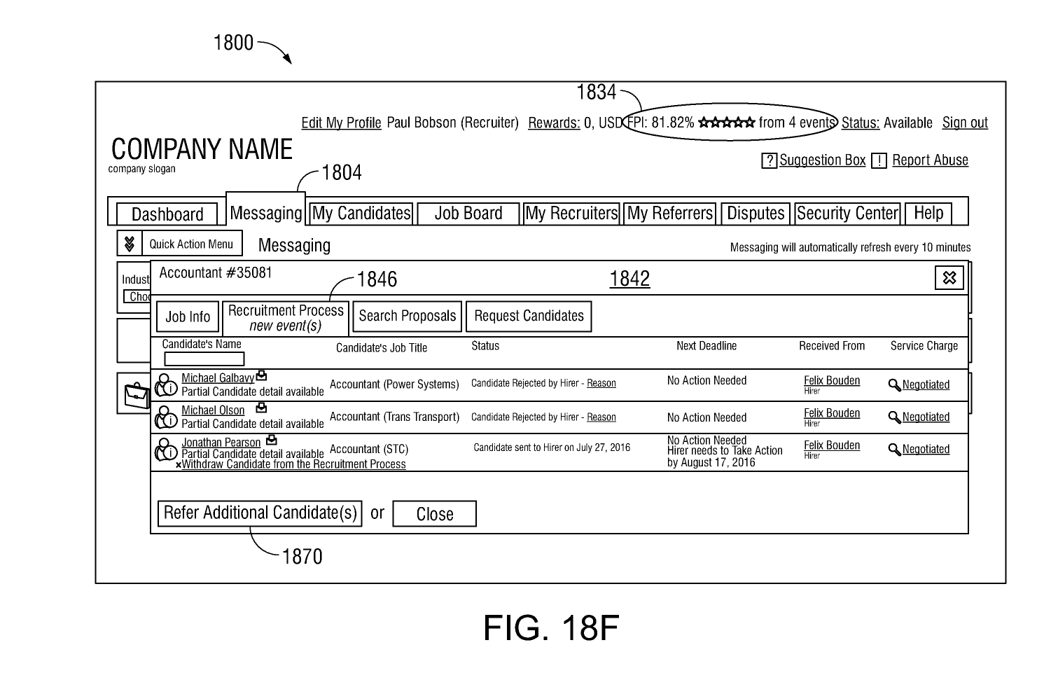

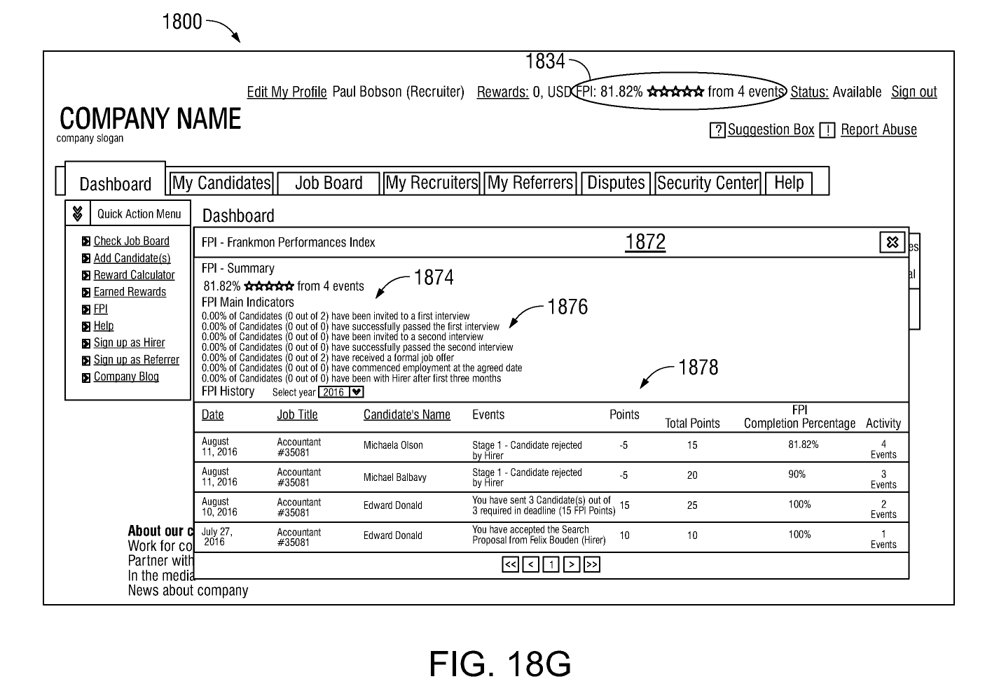

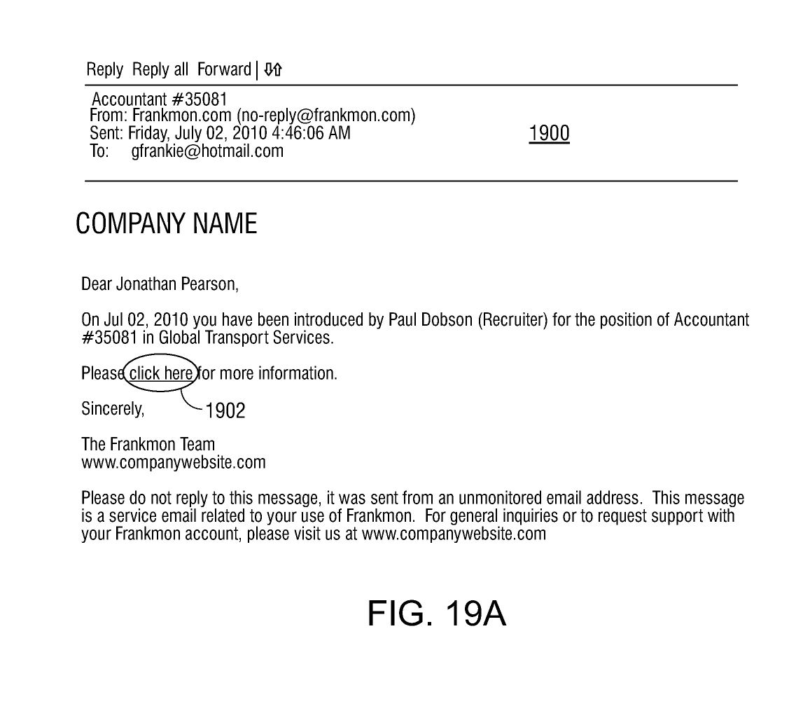

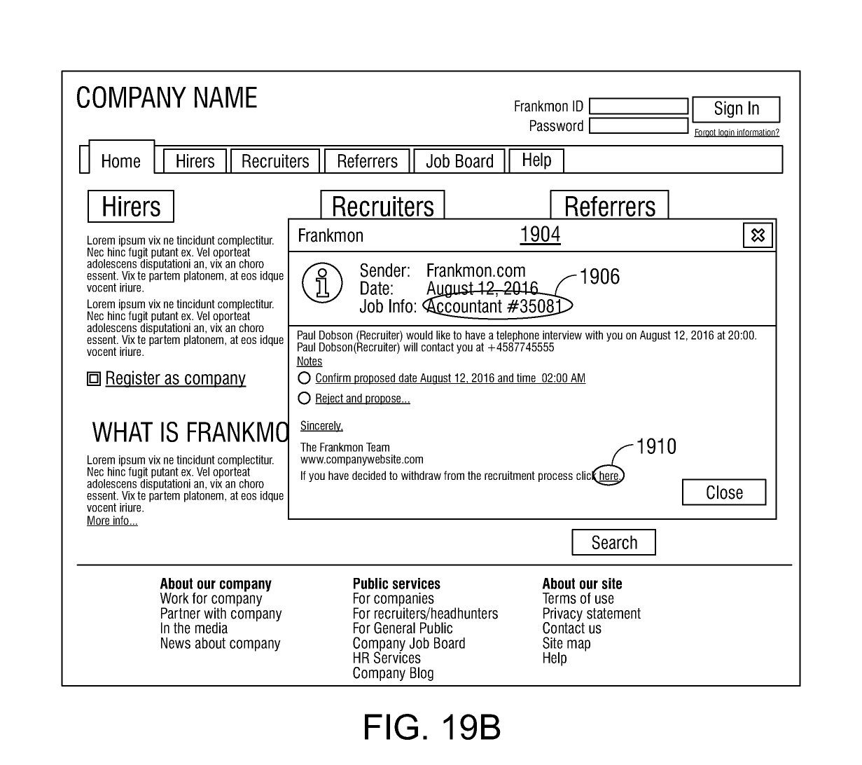

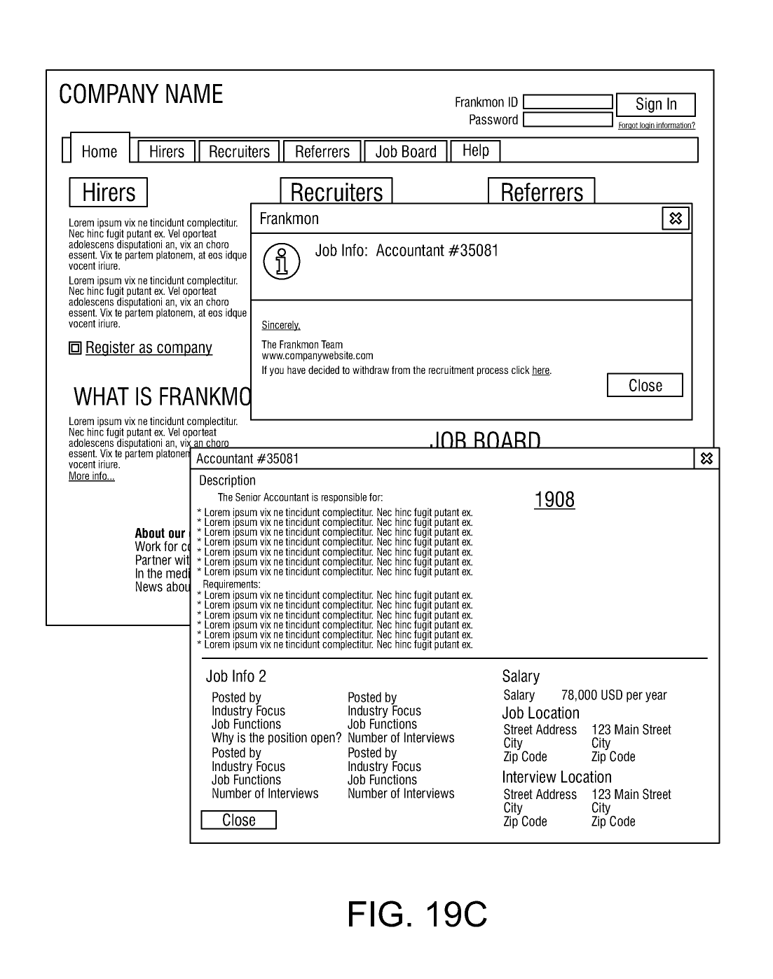

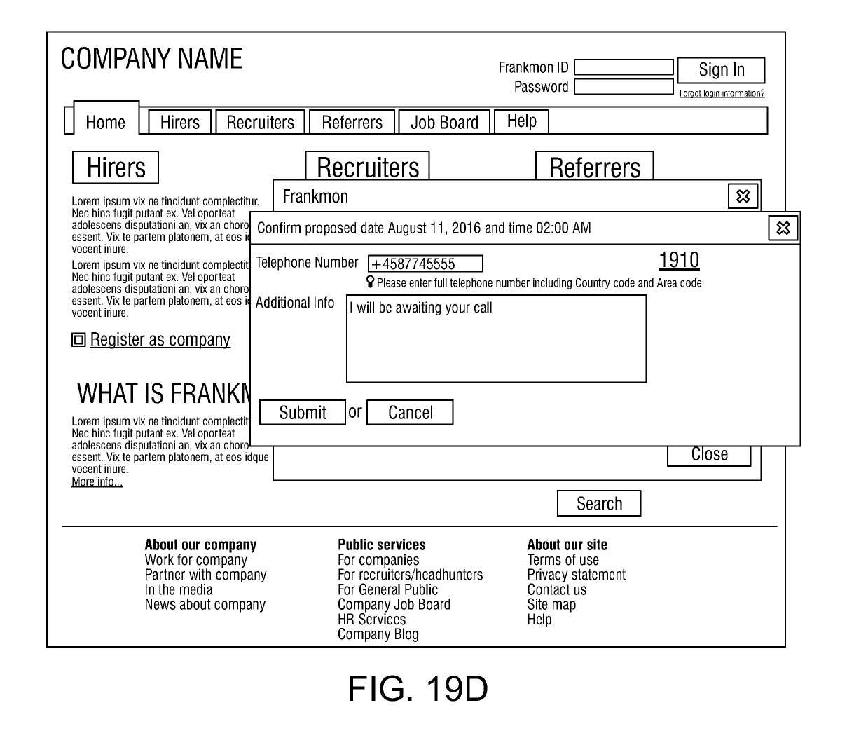

FIGS. 17A-17I illustrate several screenshots of an exemplary implementation of a Web-based user interface 1700 for the recruitment management tool 316 that may be used by hirers according to the disclosed embodiments. In a similar manner, FIGS. 18A-18G illustrate several screenshots from an exemplary implementation of a Web-based user interface 1800 for the recruitment management tool 316 that may be used by recruiters according to the disclosed embodiments. The user interface for referrers may largely resemble the user interface 1800 for recruiters and is therefore not separately shown here. FIGS. 19A-19D illustrate several screenshots of exemplary notification messages that may be sent to candidates who have been introduced to hirers by recruiters using the recruitment management tool 316 according to the disclosed embodiments. FIGS. 20A-20C illustrate several screenshots of exemplary implementation of a Web-based graphical user interface for a delegation system that may be used by hirers and recruiters. These screenshots are by no means exhaustive and are provided merely as examples of implementations of the various user interfaces and messages of the web-based recruitment management tool 316. Similarly, the look-and-feel of these exemplary screenshots and messages is illustrative only, and variations in the layout, color scheme, graphics, and other design elements are certainly within the ability of those having ordinary skill in the art.

As can be seen in FIG. 17A, the user interface 1700 may include a main screen 1702, sometimes referred to as a Dashboard screen. The Dashboard screen 1702 provides a high-level view of various job postings that currently have actions pending for a hirer. Other screens that may be present include a Messaging screen 1704 that displays the job postings that are currently in progress for the hirer, and a My Jobs screen 1706 that displays all the job postings currently in progress for the hirer (as well as completed ones). A My Candidates screen 1708 displays the candidates submitted to the hirer, a My Recruiters screen 1710 displays the recruiters available to the hirer (which may include all registered recruiters), and a My Referrers screen 1712 displays the referrers available to the hirer (which may include all registered referrers). A Disputes screen 1714 allows the hirer to lodge any disputes over fees or other issues with the service provider. A Security Center screen 1716 and a Help screen 1718 may also be present in some embodiments for allowing the hirer to manage account security (e.g., username, password, etc.) and obtain help as needed. These various screens 1702-1718 may be selected by clicking on the tab representing each screen. Displayed on the Dashboard screen 1702 is a Quick Action menu 1720 that provides hyperlinks to various useful screens and functions that the hirer may quickly access.

A Dashboard area 1722 in the Dashboard screen 1702 shows the job postings that have actions needing the hirer's attention at the moment, along with pertinent information therefor. Such information may include, for example, the job title for the posting, company name, the part(s) of the recruitment process that have activity, the part(s) of the search proposal that have been completed, and the number of candidates that have been sent and received for the job posting. The parts of the recruitment process may include, for example, candidates introduced, service charge acceptance, and the number of candidates in various stages of the interview process. In this regard, the Dashboard area 1722 may essentially be a copy of the job postings from the Messaging screen 1704 currently requiring the hirer to take some action. A deadlines area 1724 displays the upcoming deadlines for the hirer, a blog post area 1726 displays the blogs that have been posted by the hirer, and a disputes area 1728 displays any open disputes the hirer may have pending. Also present on the Dashboard screen 1702 is an identity indicator 1730 that displays the name of the hirer and an FPI indicator 1732 that shows the hirer's current FPI index.

FIG. 17B shows an example of the hirers My Jobs screen 1706. As can be seen, the My Jobs screen 1706 may provide, among other things, a post job hyperlink 1734 that allows the hirer to create a job posting. An example of a job posting is shown at 1736. The job posting 1736 may include, among other things, a description of the position needing to be filled, salary information, location information, interview information, as well as information pertaining to the hirer who posted the job posting. The My Jobs screen 1706 may also include an options hyperlink 1738 that allow the hirer, when job postings have been posted, to take various actions with respect to those job postings. This is illustrated in FIG. 17D, where a job-post hyperlink 1742 may be displayed for each job posting that has been posted.

Referring now to FIG. 17C, as part of the job posting creation process, a public/private window 1737 may be provided to allow the hirer to restrict the availability of the job posting. For example, the public/private window 1737 may allow the hirer to choose whether to publish the job posting so that it is publicly available to all users of the recruitment management tool, or keep the job posting private so that only recruiters and referrers whom the hirer subsequently selects may see the posting. In some implementations, the public/private window 1737 may also provide a filter option that allows the hirer to publish the job posting, but limit who may access the posting. For example, the filter option may allow the hirer to limit the published job posting only to recruiters and/or referrers with FPI indices greater than a certain percentage, or recruiters and/or referrers based in a certain geographical region, or those who focus on certain industries or job types, and the like.

As can be seen in FIG. 17D, clicking on the options hyperlink 1738 (FIG. 17B) for a given job posting brings up a list of actions 1740 that the hirer may take with respect to that job posting. In the present example, the job posting is Accountant #35081, as indicated at hyperlink 1742. A search area 1744 allows the hirer to search for specific job postings or groups of job postings as needed. One of the actions that the hirer may take is to send a search proposal to a recruiter for a job posting. Another action that the hirer may take is to request candidates from the recruiters. The main difference between these two actions is the search proposal allows the hirer to initiate a specific job search assignment and negotiate various aspects of the assignment, such as timing, number of candidates, whether the search is exclusive or nonexclusive with respect to the recruiter, and the like. A request for candidates, on the other hand, simply asks the recruiter to send any candidates they may already have who they think will meet the requirements of the job posting.

Selecting the search proposal action from the options hyperlink 1738 causes the user interface 1700 to bring up a list of the recruiters that are available to the hirer, which may be all of the recruiters who have registered with the recruitment management tool, or it may be a subset thereof filtered according to some predefined criteria. FIG. 17E shows an example of such a list of recruiters at 1746 along with the relevant information for each recruiter, such as their FPI index, location, industry focused, job functions, and the like. The hirer may then click on an options icon 1748 for one of the recruiters from the list and select the appropriate action to take with respect to that recruiter, such as sending the search proposal to that recruiter. In some implementations, the hirer may also designate one or more recruiters as preferred recruiters, for example, by selecting the appropriate action via the options icon 1748. Doing so may result in stars or other visual indicators being placed next to the names of those recruiters to show that they are preferred.

FIG. 17F shows an example of an activity window 1750 that may appear on the Messaging screen 1704. In general, the activity window 1750 may be brought up by clicking on an icon (one of which is partially visible here) in the Messaging screen 1704 for a job posting that the hirer has posted. If multiple job postings have been listed, then the Messaging screen 1704 displays multiple icons representing the multiple job postings. Clicking on one of these icons will bring up the activity window 1750 for that particular job posting. In the example shown here, the job posting that has been selected is Accountant #35081. As can be seen, the activity window 1750 may include a number of useful tabs, including a job info tab 1752 for displaying information about the job posting, a recruitment process tab 1754 for displaying the status and progress that has been made on the job posting with respect to the recruitment process, a search proposal tab 1756 for displaying information about the search proposal associated with the job posting, and a request candidates tab 1758 for requesting candidates for the job posting. In some embodiments, depending on which action currently needs the hirer's attention, the activity window 1750 may be configured to display the tab corresponding to that action as the active tab by default. If there are no actions needing the hirer's attention at the moment, then the activity window 1750 may be displayed with the tab corresponding to the most recently taken action as the active tab, or the tab most recently selected by the hirer as the active tab.

In the present example, the activity window 1750 is displayed with the search proposal tab 1756 as the active tab. Of course, the hirer may select one of the other tabs to view if he/she so chooses, and that tab will be made active accordingly. In any event, the search proposal tab 1756 may include several areas for displaying various information about the search proposal, including a company area for displaying the name of the recruiter who has been assigned the search proposal, a status area for displaying the status of the search proposal, and a deadlines area for displaying any actions that need to be taken in any associated therewith. In some embodiments, the deadlines area may also provide a mouse-over link 1760 that may automatically bring up a list 1762 of the actions that may be taken, either by the hirer or the recruiter, when a cursor is hovered over the hyperlink. A search type area may also be present for displaying the search type, such as contingency or exclusive. A contingency search means the hirer can engage numerous recruiters and referrers and hire candidates from whomever he/she wants, whereas an exclusive search means the hirer can only hire candidates from this particular recruiter or referrer during the delivery time that has been negotiated. After the delivery time expires, the hirer may hire whomever she/he wants.), a delivery time area for displaying the time within which candidates are to be introduced, and a service charge area for displaying whether the service charge has been negotiated or not. Note that in some embodiments, the status area may also include a preview search proposal hyperlink 1764 that, when selected, allows the hirer to view the various details associated with the search proposal.

FIG. 17G illustrates an example of the activity window 1750 with the recruitment process tab 1754 active for a particular job posting (e.g., Accountant #35081). This tab 1754, like the search proposal tab 1756, may include a number of areas, for example, a candidate name area for displaying the names of the candidates that have been submitted to the hirer, a candidate job title area for displaying their job titles, a status area for displaying their current status in the recruitment process, a next deadline area for displaying the actions and associated deadlines associated with each candidate, a received from area for displaying the recruiters who submitted the candidates, and a service charge area for indicating whether or not the service charge has been negotiated with each recruiter. In the example shown, the next deadline area may include a take action hyperlink 1766 for each candidate listed in some embodiments. Selecting this take action hyperlink 1766 for a particular candidate may bring up a list 1768 of the actions that are available to be taken with respect to that candidate.

FIG. 17H illustrates an example of the activity window 1750 from FIG. 17G wherein the hirer has rejected two of the candidates, for example, Michael Galbavy and Mikaela Olson, who are the first and second candidates listed, respectively. On the other hand, the third candidate listed, Jonathan Pearson, has been extended a job offer. As can be seen in FIG. 17H, the status area for these candidates now reflects that the hirer has rejected two of them and extended a job offer to the third candidate. In some embodiments, a reason hyperlink 1770 may be provided that, when selected, may reveal the reason that the hirer gave for rejecting the two candidates. Also, although no additional action is currently needed by the hirer at this time for the rejected candidates, an optional action hyperlink 1770 may be provided in some implementations that allows the hirer to take one more optional actions concerning those candidates. Clicking on this optional action hyperlink 1772 may bring up an option, for example, to reengage the rejected candidate. Clicking on the take action hyperlink 1774 may bring up a list of actions that the hirer may take with respect to candidate Jonathan Pearson. Note that throughout the description of the user interface 1700, as each action is taken by the hirer (and by the recruiter), his/her FPI index is automatically calculated and updated accordingly. Thus, for example, by taking the action of rejecting two candidates and extending a job offer to the third candidate within the allotted time, the hirer is able to obtain an FPI index of 100%, as shown by the FPI indicator 1732.

In some implementations, clicking on the FPI indicator 1732, or any other FPI hyperlink in the user interface 1700, may bring up an FPI window for the hirer. FIG. 17I illustrates an example of such an FPI window 1774. As can be seen, the FPI window 1774 is composed of three main areas, an FPI summary area 1776, FPI main indicators area 1778, and FPI history area 1780. The FPI summary area 1776 simply shows the accumulated total FPI for the hirer, 100% in this case. The FPI main indicators area 1778 breaks down the accumulated total FPI into several key indicators that, together with other scores that are not part of the FPI and 1778, help make up the accumulated total FPI. Examples of such main indicators for the hirer may include, for example, how prompt the hirer is in accepting service charges, in inviting candidates to interviews, in extending formal job offers, in negotiating provisional contracts, in formal contract delivery, and in confirming a candidate's commencement date. Other indicators may certainly be used in addition to or instead of the ones identified without departing from the scope of the disclosed embodiments. Such indicators provide additional information about the hirer's performance that may not necessarily be obvious from the accumulated total FBI. Finally, the FPI history area 1780 provides a list of every action the hirer has ever taken that has resulted in points being awarded to or deducted from his/her FPI.

FIG. 18A illustrates an example of a user interface 1800 that may be used by recruiters to interact with the recruitment management tool according to the disclosed embodiments. As this Figure shows, the user interface 1800 may include many of the same screens as the user interface 1700 of FIG. 17A. For example, the user interface 1800 may include a Dashboard screen 1802, a Messaging screen 1804, a My Candidates screen 1806, a Job Board screen 1808, a My Recruiters screen 1810, a My Referrers screen 1812, a Disputes screen 1814, a Security Center screen 1816, and a Help screen 1818. These screens, with the exception of the Job Board screen 1808, provide similar information as their counterparts in FIG. 17A, but from the perspective of a recruiter and not a hirer. As for the Job Board screen 1808, this screen may provide a list of all job postings available to the recruiter (which may include all job postings posted on the recruitment management tool, or a subset thereof filtered according to some predefined criteria). A Quick Action menu 1820 provides hyperlinks to various useful screens and functions that the recruiter may quickly access.

As before, a Dashboard area 1822 in the Dashboard screen 1802 shows the job postings that have actions needing the recruiter's attention at the moment, along with pertinent information therefor. Such information may include, for example, the job title for the posting, company name, the part(s) of the recruitment process that have activity, the part(s) of the search proposal that have been completed, and the number of candidates that have been sent and received for the job posting. The parts of the recruitment process and parts of the search proposal are essentially the same as their counterparts in the user interface 1700, but from the recruiter's perspective, and are therefore not separately mentioned here. In this regard, the Dashboard area 1822 may essentially be a copy of the job postings from the Messaging screen 1804 currently requiring the recruiter to take some action. A deadlines area 1824 displays the upcoming deadlines for the recruiter, a blog post area 1826 displays the blogs that have been posted by the recruiter, and a disputes area 1828 displays any open disputes the recruiter may have pending. Also present on the Dashboard screen 1802 is an identity indicator 1830 that displays the name of the recruiter, a rewards indicator 1832 that displays the compensation the recruiter has received thus far, an FPI indicator 1834 that shows the recruiter's current FPI index, and a status indicator 1836 that indicates the status of the recruiter (e.g., available, unavailable, etc.) as displayed to other users of the recruitment management tool.

FIG. 18B illustrates an example of the recruiter's Messaging screen 1804. In general, the Messaging screen 1804 displays the job postings that are currently in progress for the recruiter. To this end, the Messaging screen 1804 may include some of the same areas of information that were displayed in the dashboard area 1822 described above. In the present example, the only job posting listed is Accountant #35081, as indicated at hyperlink 1838, for which one search proposal has been received, as indicated at hyperlink 1839. However, where the recruiter is working on multiple job postings, a search area 1840 allows the recruiter to search for specific job postings or groups of job postings as needed. Clicking on the received search proposal hyperlink 1839 for a given job posting brings up an activity window 1842 for that search proposal, as shown in FIG. 18C.

Referring to FIG. 18C, the activity window 1842, like the activity window 1750 of FIG. 17D, may include a number of useful tabs, including a job info tab 1844 for displaying information about the job posting, a recruitment process tab 1846 for displaying the status and progress that has been made on the job posting with respect to the recruitment process, a search proposal tab 1848 for displaying information about the search proposal associated with the job posting, and a request candidates tab 1850 for requesting candidates for the job posting. In some implementations, depending whether there are any actions that currently need the recruiter's attention, the activity window 1842 may be configured to display the tab corresponding to that action as the active tab by default. As before, if there are no actions currently needing the recruiter's attention, then the activity window 1842 may be displayed with the tab corresponding to the most recently taken action as the active tab, or the tab most recently selected by the recruiter as the active tab.

In the example shown, the activity window 1842 is displayed with the search proposal tab 1848 as the active tab. Of course, the recruiter may select one of the other tabs to view if he/she so chooses, and that tab will be made active accordingly. In any event, the search proposal tab 1848 may include several areas for displaying various information about the search proposal, including a company area, a status area, a deadlines area, a search type area, a delivery time area, and a service charge area. These areas are essentially the same as their counterparts in the activity window 1750 described above, except that the information they display are from the perspective of the recruiter. The deadlines area, in some embodiments, may provide a hyperlink 1852 that may automatically bring up a list 1854 of the actions that may be taken by the recruiter. In some embodiments, a mouse over link 1842 may be provided that may bring up a list of the actions that may be taken by hirer. In some embodiments, a preview search proposal hyperlink 1856 is provided in the status area that, when selected, allows the recruiter to view the various details associated with the search proposal.

Clicking on the preview search proposal hyperlink 1856 brings up a search proposal window 1858 that provides additional information concerning the search proposal. An example of this search proposal window 1858 is illustrated in FIG. 18D, which shows the various terms of the proposal, including the search type, the delivery time, the service charge (e.g., a percentage of the candidate's salary, a fixed fee, etc.), the percentage amount and salary basis (if the service charge is a percentage of salary), and whether the search proposal is exclusive to the recruiter or other recruiters may be involved. Recall from earlier that a contingency search means the hirer can engage multiple recruiters and referrers, while an exclusive search means the hirer can only hire candidates from a particular recruiter or referrer during the negotiated delivery period. Once the delivery time expires, of course, then hirer can hire candidates from whomever she/he wants. The recruiter may then accept the search proposal, propose changes to the terms of the proposal, or reject the search proposal by selecting the appropriate action from the list of actions 1854 (see FIG. 18C). Note that regardless of the specific action, as long as the recruiter takes an action before the deadline indicated, then he/she will be automatically awarded an appropriate number of FPI points accordingly.

FIG. 18E illustrates an example of a submit candidates window 1860 that the recruiter may use to submit candidates to the hirer for a given job posting. Although not entirely visible here, such a submit candidates window 1860 may be accessed from the Messaging screen 1804 by clicking on an options icon in that screen and selecting the appropriate action (e.g., refer candidates) from a list of actions that is subsequently brought up. In some implementations, this submit candidates window 1860 may include a search area 1862 or allowing the recruiter to search for candidates who may be suitable for the job posting. Once one or more candidates have been found, for example, the candidate named Jonathan Pearson and indicated at 1864, the recruiter may click on an options icon 1866 for that candidate. Doing so brings up a list 1866 of options that the recruiter may thereafter take with respect to that candidate, including selecting the candidate for submission to the hirer. Alternatively, or in addition, the recruiter may click on an add new candidate hyperlink 1870 that allows the recruiter to add new candidates not already part of his/her mind candidates list.

FIG. 18F illustrates an example of the activity window 1842 with the recruitment process tab 1846 active for the exemplary Accountant #35081 job posting. This tab 1846, like the search proposal tab 1848, may include a number of areas, for example, a candidate name area, a candidate job title area, a status area, a next deadline area, a sent to area for displaying the hirers to whom each candidate was submitted, and a service charge area for indicating whether or not the service charge has been negotiated with each hirer. As can be seen, the hirer has rejected two of the candidates, Michael Galbavy and Mikaela Olson. A reasoned hyperlink may be provided for each rejected candidate that, when selected, displays the reason provided by the hirer for the rejection. However, the hirer has not taken any action on the other candidate, Jonathan Pearson. Therefore, the next deadline area for Mr. Pearson indicates that the hirer needs to take action and displays the date by which the action needs to be taken. In some embodiments, a refer additional candidates button 1870 may be provided to allow the recruiter to refer additional candidates to the hirer. Note that because points have been automatically deducted from the recruiter as a consequence of two of the candidates he/she submitted having been rejected, the recruiter's FPI indicator 1834, which may be automatically calculated and updated, is less than 100%.

Clicking on the FPI indicator 1834, or any other FPI hyperlink in the user interface 1800, may bring up an FPI window for the recruiter. FIG. 18G illustrates an example of such an FPI window 1872. As can be seen, the FPI window 1872, like its counterpart in FIG. 17I, is composed of three main areas, an FPI summary area 1874, FPI main indicators area 1876, and FPI history area 1878. The FPI summary area 1874 simply shows the accumulated total FPI for the recruiter, less than 100% in this case. The FPI main indicators area 1876 separates out the accumulated total FPI into a number of useful indicators that together make up the accumulated total. Examples of such main indicators for a recruiter may include, for example, the percentage of candidates who have been invited to a first interview, passed the first interview, invited to a second interview, past the second interview, received a formal job offer, commenced employment at the agreed-upon date, and stayed with the hirer for at least three months. Other indicators besides the ones described may certainly be used without departing from the scope of the disclosed embodiments. Such indicators provide additional information about the recruiter's performance that may not necessarily be obvious from the accumulated total FPI. Lastly, the FPI history area 1878 provides a list of every action the recruiter has ever taken that has resulted in points being awarded to or deducted from his/her FPI.

When a hirer invites a candidate to an interview, whether a first, second, or third interview, the recruitment management tool automatically sends an e-mail notification to the candidate specifying the date, time, interviewer, and the particular job posting for which he he/she has been invited to interview. FIG. 19A illustrates an example of such an e-mail notification 1900. The e-mail notification 1900 may take any number of formats and layout, but preferably includes a hyperlink 1902 that, when selected, launches a Web browser that takes the candidate to the URL of the Web-based recruitment management tool. At the Web based recruitment management tool, the candidate is provided with a hyperlink (not expressly shown) of the particular job posting for which he/she has been invited to interview. The candidate may click on that hyperlink to bring up an interview confirmation window 1904, an example of which is illustrated in FIG. 19B. As can be seen, in some embodiments, the interview confirmation window 1904 may include options for the candidate to either confirm the date and time of the interview, or reject the date and time and propose a new interview date and time. Also included in the interview confirmation window 1904 is a hyperlink 1906 for the job posting, clicking on which brings up a detailed description window 1908 that contains a detailed description of the position for which the candidate has been invited to interview. This detailed description window 1908 is shown in FIG. 19C. Selecting the confirm option automatically alerts the hirer and the recruiter accordingly, and brings up a message window 1910, as shown in FIG. 19D, for allowing the candidate to send additional information or comments to the hirer. A similar window (not expressly shown) may be brought up for allowing the candidate to propose an alternative interview date and time if needed. Referring back to FIG. 19B, the interview confirmation window 1904 may also include a withdrawal hyperlink 1912 or allowing the candidate to remove his/her profile from further consideration for the position. Clicking on the withdrawal hyperlink 1910 automatically notifies the hirer and the recruiter that the candidate has withdrawn. The FPI for the recruiter is thereafter automatically updated accordingly as a result of the withdrawal.

In addition to the above user interfaces, in some embodiments, the Web-based recruiting management tool may also include a user interface for a delegation system. The delegation system, as the name suggests, allows hirers and recruiters who are supervisors to connect to their subordinates in order to see how their subordinates are performing and how efficient is their recruitment process. This helps recruiters and hirers manage their teams more efficiently and effectively. Such a delegation system also allows supervisors to take action on behalf of their subordinates in some embodiments, which may be useful, for example, when a subordinate abruptly leaves the company or is otherwise unavailable. Although not expressly shown, in some implementations, hirers and recruiters may access the delegation system via an option in the Quick Action Menu 1720 or 1820 (see FIGS. 17A and 18A). Alternatively, or in addition, the delegation system may be accessed via a separate tab similar to the Dashboard tab or the Messaging tab, and the like.

Turning now to FIGS. 20A-20C, an example of a user interface 2000 is shown for the delegation system. Referring first to FIG. 20A, in one implementation, the user interface 2000 may include an add user screen 2002 configured to allow a participant to add supervisors and subordinates to the account of the participant. As can be seen, the add user screen 2002 may include a current user box 2004 for displaying the name of the current participant and one or more supervisor boxes and subordinate boxes, only one shown here at 2006 for illustrative purposes, for displaying the names of any supervisors and/or subordinates that have been added to the participant's account. In the example shown, supervisory recruiter John Smith, the current participant, has added a subordinate recruiter, Joe Givens, to his account, as indicated by the subordinate box 2006. Supervisory recruiter John Smith may now view the account of subordinate recruiter Joe Givens, for example, by clicking on a hyperlink in the subordinate box 2006 of Mr. Givens. In this way, Mr. Smith may see the various job postings that Mr. Givens is currently working on, the status of those job postings, and how effective and efficient Mr. Givens is performing with respect to those job postings. Thus, for example, if Mr. Givens FPI should fall below a predefined level, Mr. Smith may address the issue with Mr. Givens in a timely manner.

An edit supervisor button 2008 and an edit subordinate button 2010 may also be provided to allow the current participant to add, remove, and/or modify supervisors and subordinates as needed. Clicking on the edit supervisor button 2008 or edit subordinate button 2010 may open a window wherein the current participant may enter the name and/or e-mail address of the supervisor and/or subordinate he/he wishes to add, or from whom the participant wishes to be disconnected. Doing so may bring up a list of personnel from which the participant may choose. Once the participant has disconnected himself/herself from a supervisor and/or subordinate, or has invited a supervisor and/or subordinate to connect to the participant, the Web-based recruitment management tool automatically sends a message to the appropriate user either notifying the user that the current participant has disconnected from that user, or requesting the user to connect to the current participant. When a user is disconnected from the participant, any subordinates connected to the user are also disconnected from the participant. Likewise, when a user is connected to a participant, any subordinates connected to the user are also connected to the participant.

FIG. 20B illustrates an example of a status screen 2012 that may be provided by the user interface 2000 for allowing a participant to view the statuses of the various connect requests that have either been received by the participant, or that the participant has sent to other users. In the example shown here, the participant has sent one connect request to recruiter Steven Hurley that is still pending, one connect request to recruiter Jonathan Blue that has been accepted, and one request to recruiter Steven Smith that has been rejected.

In addition to allowing a participant to manually monitor the FPI of each subordinate connected to the participant (i.e., his/her network), in one implementation, the delegation system may also automatically send a report of the FPI of the various subordinates thusly connected to the participant. This is depicted in FIG. 20C, which illustrates an example of an FPI report screen 2014 that may be provided by the user interface 2000 for allowing the participant to specify the various details of such an auto-generated FPI report. For example, the participant may elect to have the FPI report sent daily, weekly, monthly, quarterly, and the like. Similarly, the participant may choose to have the FPI report contain the FPI, the FPI main indicators, the FPI history, and/or a snapshot of the Dashboard for each subordinate in the participant's network.

While the disclosed embodiments have been described with reference to one or more particular implementations, these implementation are not intended to limit or restrict the scope or applicability of the invention. Those having ordinary skill in the art will recognize that many modifications and alterations to the disclosed embodiments are available. For example, as alluded to above, in some implementations, if a hirer initially rejects a candidate who was introduced by a recruiter or referrer, but nevertheless saves the candidate into his/her My Candidates list, the Web-based recruitment management tool may automatically put a note next to the candidate saying that if the hirer subsequently hires the candidate for another, different job posting, the hirer is responsible for paying the fee that was originally negotiated with the recruiter or owed to the referrer. This fee protection for the recruiter and/or referrer may be kept in place for 12 months from the original introduction (for referrers) or from the acceptance of the service charge (for recruiters). Likewise, in some implementations, when Recruiter 1 requests a candidate from another recruiter, Recruiter 2, the candidate is also placed under a 12-month fee protection period. This means that if Recruiter 1 introduces the candidate for any job opportunity through the Web-based recruitment management tool, the tool automatically notifies Recruiter 2, and Recruiter 1 will need to share with Recruiter 2 the fee received according to the original agreement between the two of them (before Recruiter 2 provided the candidate's details to Recruiter 1). A similar fee protection arrangement may also be implemented for recruiter-to-referrer candidate introductions.

Therefore, each of the foregoing embodiments and obvious variations thereof is contemplated as falling within the spirit and scope of the disclosed inventions, which are set forth in the following claims.

1. A computer-based method of managing an employment recruitment process, comprising:
creating a first user account for a first participant in the recruitment process and a second user account for a second participant in the recruitment process, the first user account and the second user account having a first performance index and a second performance index associated therewith, respectively;
completing a first recruiting related action selected by the first participant, the first recruiting related action being triggered by completion of a previous recruiting related action selected by the second participant;
awarding or deducting points for the first participant for completion of the first recruiting related action based on a first objective criterion;
completing a second recruiting related action selected by the second participant, the second recruiting related action being triggered by completion of a previous recruiting related action selected by the first participant;
awarding or deducting points for the second participant for completion of the second recruiting related action based on a second objective criterion; and
updating the first performance index using the completion of the first recruiting related action and the points awarded or deducted therefor, and updating the second performance index using the completion of the second recruiting related action and the points awarded or deducted therefor, the first and second performance indices providing an objective indication of the past performances of the first and second participants, respectively.

2. The method according to claim 1, further comprising automatically notifying the second user account when the first recruiting related action has been completed and automatically notifying the first user account when the second recruiting related action has been completed.

3. The method according to claim 1, wherein:
the first recruiting related action is selected by the first participant from a first set of recruiting related actions, the first set of recruiting related actions being defined based on the previous recruiting related action selected by the second participant; and
the second recruiting related action is selected by the second participant from a second set of recruiting related actions, the second set of recruiting related actions being defined based on the previous recruiting related action selected by the first participant.

4. The method according to claim 1, wherein each of the first and second objective criteria include one or more of: a timing criterion, and a quantity criteria.

5. The method according to claim 1, wherein the first performance index and the second performance index each comprise: a performance percentage, and number of events, where an event is a recruiting related action for which points were awarded or deducted.

6. The method according to claim 5, wherein the performance percentage is calculated using the following formula: performance percentage=(current total point−minimum point total)/(maximum point total−minimum point total).

7. The method according to claim 1, further comprising completing a third recruiting related action selected by a third participant, the third recruiting related action being triggered by completion of a previous recruiting related action selected either by the first participant or the second participant, wherein no user account is created for the third participant.

8. The method according to claim 7, wherein the first participant is a hirer, the third participant is an employment candidate, and the second participant is one of: a recruiter, and a referrer.

9. A computer-based system for standardizing an employment recruitment process, comprising:
at least one subsystem configured to complete a hirer related action selected by a hirer in the recruiting process;
at least one subsystem configured to award or deduct points for the hirer for completion of the hirer related action based on a first objective criterion;
at least one subsystem configured to complete a recruiter related action selected by a recruiter in the recruiting process, the recruiter related action being triggered by completion of the hirer related action selected by the hirer;
at least one subsystem configured to award or deduct points for the recruiter for completion of the recruiter related action based on a second objective criterion; and
at least one subsystem configured to update a hirer performance index using the completion of the hirer related action and the points awarded or deducted therefor, and update a recruiter performance index using the completion of the recruiter related action and the points awarded or deducted therefor, the hirer and recruiter performance indices providing an objective indication of the past performances of the hirer and recruiter, respectively.

10. The system according to claim 9, wherein the employment recruitment process includes one or more of the following: (a) search proposal negotiation between recruiter and hirer, (b) service charge negotiation between recruiter and hirer, (c) service charge split negotiation between recruiters, (d) recruitment process between hirer and referrer, (e) recruitment process between hirer and recruiter, and (f) recruiter requesting candidate(s) from referrer.

11. The system according to claim 9, wherein the first and second objective criteria include one or more of: a first time within which to complete an action and a second time within which to complete an action, the second objective criterion further including a first number of candidates submitted, a second number of candidates submitted, and a third number of candidates submitted.

12. The system according to claim 9, wherein the hirer performance index comprises multiple main indicators, including: how prompt the hirer is in accepting service charges, how prompt the hirer is in inviting candidates to interviews, how prompt the hirer is in extending formal job offers, how prompt the hirer is in negotiating provisional contracts, how prompt the hirer is in formal contract delivery, and how prompt the hirer is in confirming a candidate's commencement date.

13. The system according to claim 9, wherein the recruiter performance index comprises multiple main indicators, including: percentage of candidates who have been invited to a first interview, percentage of candidates who have passed the first interview, percentage of candidates who have been invited to a second interview, percentage of candidates who have past the second interview, percentage of candidates who have received a formal job offer, percentage of candidates who have commenced employment at the agreed-upon date, and percentage of candidates who have stayed with the hirer for at least three months.

14. The system according to claim 9, further comprising at least one subsystem configured to publish job postings created by the hirer in the computer-based system, the job postings being accessible to one of the following: all users of the computer-based system, individual users specifically selected by the hirer, users who satisfy one or more predefined criteria selected by the hirer.

15. The system according to claim 14, further comprising at least one subsystem configured to automatically send a notification message to an employment candidate when the hirer has invited the employment candidate to an interview, the notification message including instructions for allowing the employment candidate to access the computer-based system to: (a) confirm the time and date of the interview, (b) propose a different time and date for the interview, or (c) withdraw from the employment recruitment process.

16. A computer-based system for managing an employment recruitment process, comprising:
one or more databases configured to store data concerning recruiters, referrers, hirers, jobs, and employment candidates;
at least one server connected to the one or more databases and configured to access the data stored on the one or more databases, the at least one server including a non-transitory storage medium encoded with computer-readable instructions for causing the at least one server to:
automatically award or deduct points for a participant based on the participant's performance in the employment recruitment process using one or more objective criteria, the awarding or deducting being conducted without scoring-related input from other participants in the employment recruitment process; and
provide a performance index for each participant, the performance index composed of a performance percentage and number of events, where an event is a recruiting related action for which points were awarded or deducted by the at least one server, and the performance percentage is a percentage reflecting the number of points a participant has earned relative to the total number of points that the participant could have earned.

17. The system according to claim 16, wherein the computer-readable instructions further cause the at least one server to connect one or more supervisory participants and/or subordinate participants to the participant.

18. The system according to claim 17, wherein the computer-readable instructions further cause the at least one server to automatically send a performance index report of the subordinate participants who are connected to the participant.

19. The system according to claim 17, wherein the computer-readable instructions further cause the at least one server to track a status of one or more requests to connect that are sent to the participant and/or sent by the participant.

20. The system according to claim 16, wherein the computer-readable instructions further cause the at least one server to implement fee protection for the participant based on a candidate introduced by the participant for a first job posting, but who is hired for a second job posting.
